(19) United States
(12) Patent Application Publication
(10) Pub. No.: US 2024/0367988 A1
(43) Pub. Date: Nov. 7, 2024

(54) CHLORITE COMPOSITIONS

(71) Applicant: Neuvivo, Inc., Palo Alto, CA (US)

(72) Inventors: Chaminda P. GAMAGE, Florence, SC (US); Charles David GAGLIARDI, Greer, SC (US); Kirt Lyvell MATTHEWS, SR., Fort Mill, SC (US); Tyler H. ASLUND, Florence, SC (US)

(21) Appl. No.: 18/639,357

(22) Filed: Apr. 18, 2024

Related U.S. Application Data
(60) Provisional application No. 63/497,342, filed on Apr. 20, 2023.

(51) Int. Cl. C01D 3/24

(52) U.S. Cl. CPC C01D 3/24; C01P 2006/80

(57) ABSTRACT

Provided herein are apparatus and methods for production of a chlorite salt, e.g., sodium chlorite, based on purification by recrystallization to achieve the desired purity.

### CROSS REFERENCE

This application claims the benefit of U.S. Provisional Application No. 63/497,342 filed on Apr. 20, 2023, which is entirely incorporated herein by reference.

### BACKGROUND

Amyotrophic lateral sclerosis (ALS) is a progressive neurodegenerative disease that destroys motor neurons in the brain and spinal cord, eventually leading to muscle paralysis, and death, usually within 2-4 years of diagnosis. Most ALS patients lack any sort of effective treatment.

Sodium chlorite is a strong oxidizer and is highly corrosive and toxic by inhalation/skin absorption. Safe handling during manufacture requires specialized procedures, including use of a respirator, safety shields, use of glass jacketed reactors, avoidance of contact with organics or low pH, no contact with metals, segregation of all waste (in plastic containers), no discharge to sanitary sewers, and careful maintenance of wet filter cakes during processing.

### SUMMARY OF THE INVENTION

In some embodiments, the present disclosure provides an article of manufacture comprising: a) an inner packaging material, wherein the inner packaging material is substantially free of acid, metal, and organic chemicals, wherein the inner packaging material is substantially airtight; b) an outer packaging material, wherein the outer packaging material is substantially opaque; and c) a sample of solid sodium chlorite in an amount of at least one kilogram and a purity of at least 96%, wherein the solid sodium chlorite is packaged in the inner packaging material such that the solid sodium chlorite is not exposed to acid, metal, and organic chemicals; and wherein the inner packaging material is packaged within the outer packaging material such that the solid sodium chlorite is not exposed to ambient light. In some embodiments, the solid sodium chlorite has a purity of at least about 98%. In some embodiments, the solid sodium chlorite has a purity of at least about 99%. In some embodiments, the single portion is at least 10 kg, at least 100 kg, at least 1000 kg, or more. In some embodiments, the composition further comprises sodium chloride. In some embodiments, the composition further comprises sodium chlorate. In some embodiments, the composition is in a pharmaceutically-acceptable container. In some embodiments, the inner packaging material is glass or HDPE. In some embodiments, the outer packaging material is HDPE.

In some embodiments, the present disclosure provides an article of manufacture comprising a plurality of unit dosage forms, wherein each unit dosage form independently comprises: a) a solute, wherein at least 96% of the solute by mass is sodium ions and chlorite ions; and b) phosphate buffer, wherein the solute is dissolved in the phosphate buffer, wherein each unit dosage form independently has a pH of about 7 to about 11, wherein each unit dosage form is independently packaged in pharmaceutically-acceptable packaging, each providing a packaged dose; wherein the packaged doses are contained in a pharmaceutically-acceptable container; and wherein the amounts of the sodium ions and the chlorite ions in the unit dosage forms in the pharmaceutically-acceptable container sum to a total of at least 1 kilogram. In some embodiments, at least 98% of the solute by mass is sodium ions and chlorite ions. In some embodiments, at least 99% of the solute by mass is sodium ions and chlorite ions. In some embodiments, the total is at least 10 kg, at least 100 kg, at least 1,000 kg, or more. In some embodiments, the solute further comprises sodium chloride. In some embodiments, solute further comprises sodium chlorate. In some embodiments, each unit dosage form independently has a pH of about 7 to about 9.5. In some embodiments, each unit dosage form independently has a pH of about 7.5 to about 9.

In some embodiments, the present disclosure provides an apparatus comprising: a) a glass chamber, wherein the glass chamber is double-walled, airtight, substantially free of air, substantially free of metal, substantially free of acid, substantially free of organic chemicals, wherein the glass chamber comprises a bottom and has a volume of at least one liter; b) an access port attached to the glass chamber, wherein: 1) the access port is configured to allow insertion of a sample tool into the glass chamber from outside the glass chamber when the access port is open; and 2) the access port forms an air-tight seal when the access port is closed; c) a filter inside the glass chamber at the bottom of the glass chamber, wherein: 1) the filter is corrosion resistant; and 2) the filter is resistant to chemical reactivity with sodium chlorite; and d) a temperature-regulating element, wherein the temperature-regulating element is in contact with the glass chamber such that the temperature-regulating element is disposed to regulate temperature within the glass chamber. In some embodiments, the volume of the glass chamber is at least ten liters. In some embodiments, the volume of the glass chamber is at least one hundred liters. In some embodiments, the glass chamber is borosilicate glass. In some embodiments, the glass chamber is type 1 class A borosilicate glass. In some embodiments, the filter is plastic. In some embodiments, the filter is polytetrafluoroethylene.

In some embodiments, the present disclosure provides a composition comprising: a) a solute in an amount of at least one kilogram, wherein at least 96% of the solute by mass is sodium ions and chlorite ions; and b) water, wherein the solute is dissolved in the water at a level of about 100 mg/mL to about 125 mg/mL. In some embodiments, at least 98% of the solute by mass is sodium ions and chlorite ions. In some embodiments, at least 99% of the solute by mass is sodium ions and chlorite ions. In some embodiments, the amount is at least 10 kg, at least 100 kg, at least 1000 kg, or more. In some embodiments, the solute further comprises sodium chloride. In some embodiments, the solute further comprises sodium chlorate. In some embodiments, the composition is in a pharmaceutically-acceptable container.

In some embodiments, the present disclosure provides a composition comprising solid sodium chlorite in a single portion of at least one kilogram. In some embodiments, the solid sodium chlorite has a purity of at least about 96%, at least about 98%, at least about 99%, or more. In some embodiments, the single portion is at least 10 kg, at least 100 kg, at least 1000 kg, or more. In some embodiments, the composition further comprises sodium chloride. In some embodiments, the composition further comprises sodium chlorate. In some embodiments, the composition is in a pharmaceutically-acceptable container.

In some embodiments, the present disclosure provides a composition comprising: a) a solute in an amount of at least one kilogram, wherein at least 96% of the solute by mass is sodium ions and chlorite ions; and b) phosphate buffer, wherein the solute is dissolved in the phosphate buffer. In some embodiments, at least 98% of the solute by mass is sodium ions and chlorite ions. In some embodiments, at least 99% of the solute by mass is sodium ions and chlorite ions. In some embodiments, the amount is at least 10 kg, at least 100 kg, at least 1.000 kg, or more. In some embodiments, the solute further comprises sodium chloride. In some embodiments, the solute further comprises sodium chlorate. In some embodiments, the composition is in a pharmaceutically-acceptable container. In some embodiments, the phosphate buffer has a pH of about 7 to about 11. In some embodiments, the phosphate buffer has a pH of about 7 to about 9.5. In some embodiments, the phosphate buffer has a pH of about 7.5 to about 9.

In some embodiments, the present disclosure provides a method comprising: a) contacting crude sodium chlorite with a liquid, thereby generating a sodium chlorite mixture; and b) obtaining purified sodium chlorite from the sodium chlorite mixture, wherein the purified sodium chlorite has a purity of at least 96%.

In some embodiments, the crude sodium chlorite is up to about 80% pure. In some embodiments, the liquid comprises water. In some embodiments, the liquid comprises pharma water. In some embodiments, the liquid comprises water for injection. In some embodiments, the contacting is performed at a temperature from about 50° C. to 100° C. In some embodiments, the contacting is performed at a temperature of about 70° C. In some embodiments, the contacting is performed with agitation of the sodium chlorite mixture. In some embodiments, the method further comprises, subsequent to a) and prior to b), passing the sodium chlorite mixture through a filter. In some embodiments, the method further comprises, subsequent to a) and prior to b), passing the sodium chlorite mixture through a 0.2 micro cartridge filter. In some embodiments, b) is performed in a chamber, wherein the chamber is airtight and is substantially free of air, metal, acid, and organic chemicals. In some embodiments, the contacting the crude sodium chlorite with the liquid comprises substantially dissolving the crude sodium chlorite in the liquid. In some embodiments, the obtaining the purified sodium chlorite from the sodium chlorite mixture comprises separating a solid phase of the sodium chlorite mixture from a liquid phase of the sodium chlorite mixture. In some embodiments, the obtaining the purified sodium chlorite from the sodium chlorite mixture comprises separating a solid phase of the sodium chlorite mixture from a liquid phase of the sodium chlorite mixture, wherein the solid phase of the sodium chlorite mixture comprises crystalline sodium chlorite. In some embodiments, the obtaining the purified sodium chlorite from the sodium chlorite mixture comprises crystallizing the purified sodium chlorite from the sodium chlorite mixture. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to about 10° C. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; further comprising separating the solid phase from the liquid phase. In some embodiments, the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; further comprising separating the solid phase from the liquid phase by filtration. In some embodiments, the solid phase comprises crystalline sodium chlorite. In some embodiments, the method further comprises measuring a purity of the purified sodium chlorite. In some embodiments, the method further comprises measuring a purity of the purified sodium chlorite, and: i) if the purity meets a threshold purity value, collecting the sodium chlorite; or ii) if the purity does not meet the threshold purity value, dissolving the purified sodium chlorite in a solvent and recrystallizing the purified sodium chlorite from the solvent, wherein the threshold purity value is at least 96% pure. In some embodiments, the method further comprises transferring the purified sodium chlorite to a container. In some embodiments, the method further comprises dissolving the purified sodium chlorite in water. In some embodiments, the method further comprises dissolving the purified sodium chlorite in water to provide dissolved sodium chlorite, wherein the dissolved sodium chlorite is in water at a level of about 100 mg/mL to about 125 mg/mL. In some embodiments, the method further comprises processing the purified sodium chlorite into a plurality of unit dosage forms, wherein each unit dosage form independently comprises purified sodium chlorite dissolved in phosphate buffer at a pH of about 7 to about 11. In some embodiments, the method further comprises packaging the plurality of unit dosage forms into pharmaceutically-acceptable packaging. In some embodiments, the contacting the crude sodium chlorite with the liquid comprises contacting at least about 100 g, at least about 500 g, at least about 1,000 g, at least about 1,500 g. or more of crude sodium chlorite with the liquid. In some embodiments, the obtaining the purified sodium chlorite obtains at least about 1 kg of purified sodium chlorite.

In some embodiments, the present disclosure provides a method comprising: a) substantially dissolving crude sodium chlorite in a liquid at a temperature from about 50° C. to 100° C. with agitation thereby generating a sodium chlorite mixture, wherein the crude sodium chlorite is up to about 80% pure, wherein the liquid comprises water; b) passing the sodium chlorite mixture through a filter to a glass chamber, wherein the glass chamber is airtight and is substantially free of air, metal, acid, and organic chemicals; c) freezing the sodium chlorite mixture in the glass chamber to provide a frozen sodium chlorite mixture; d) heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; and e) separating the solid phase from the liquid phase by filtration, wherein the solid phase comprises crystalline sodium chlorite.

In some embodiments, the water comprises pharma water. In some embodiments, the water comprises water for injection. In some embodiments, the dissolving is performed at a temperature of about 70° C. In some embodiments, the filter is a 0.2 micro cartridge filter. In some embodiments, the heating the frozen sodium chlorite mixture is to about 10° C. In some embodiments, the method further comprises measuring a purity of the purified sodium chlorite, and: i) if the purity meets a threshold purity value, collecting the sodium chlorite; or ii) if the purity does not meet the threshold purity value, dissolving purified the sodium chlorite in a solvent and recrystallizing the purified sodium chlorite from the solvent, wherein the threshold purity value is at least 96% pure. In some embodiments, the method further comprises transferring the purified sodium chlorite to a container. In some embodiments, the method further comprises dissolving the purified sodium chlorite in water. In some embodiments, the method further comprises dissolving the purified sodium chlorite in water to provide dissolved sodium chlorite, wherein the dissolved sodium chlorite is in water at a level of about 100 mg/ml to about 125 mg/mL. In some embodiments, the method further comprises processing the purified sodium chlorite into a plurality of unit dosage forms, wherein each unit dosage form independently comprises purified sodium chlorite dissolved in phosphate buffer at a pH of about 7 to about 11. In some embodiments, the method further comprises packaging the plurality of unit dosage forms into pharmaceutically-acceptable packaging. In some embodiments, the crude sodium chlorite has a mass of at least about 100 g, at least about 500 g, at least about 1,000 g, at least about 1,500 g, or more. In some embodiments, the solid phase comprises crystalline sodium chlorite in an amount of at least about 1 kg of purified sodium chlorite.

### BRIEF DESCRIPTION OF THE DRAWINGS

FIG. 1 shows an example of a cross-section view of a purification apparatus.

FIG. 2 shows another example of a cross-section view of a purification apparatus.

FIG. 3 shows examples of purification apparatuses with different sizes and dimensions.

FIG. 4 shows an example of a purification process.

FIG. 5 shows an example of a transfer and filtrate collection process.

FIG. 6 shows an example of a transfer and packaging process.

FIG. 7 illustrates an example of a reactor for sodium chlorite purification.

FIG. 8 illustrates an example of a filter support assembly.

FIG. 9 shows an example of a reactor.

FIG. 10 shows a section view of an example reactor.

FIG. 11 illustrates an example of the purification method 1100.

FIG. 12 illustrates an example of the purification method 1200.

### DETAILED DESCRIPTION

Provided herein are apparatuses and methods for production of sodium chlorite, based on purification of technical-grade sodium chlorite (up to 80% purity) to higher purity, for example, at least about 96% purity recrystallization to achieve the required purity, and compositions thereof.

Amyotrophic lateral sclerosis (ALS) is a fatal neurodegenerative disease associated with inappropriate immune system dysfunction involving NF-kB activation, proinflammatory factor production and progressive changes in motor neuron function.

Macrophages are white blood cells produced by the division of monocytes. Monocytes and macrophages are phagocytes and play a role in innate immunity (non-specific immune defenses) and helping to initiate adaptive immunity (specific defense mechanisms). These cells phagocytose (engulf and then digest) cellular debris and pathogens either as stationary or as mobile cells. When activated by pathogens or by other mechanisms, macrophages stimulate and recruit lymphocytes and other immune cells to respond. Activated macrophages are involved in the progression of diseases and disorders including amyotrophic lateral sclerosis (ALS). Activated macrophages elicit massive leukocyte infiltration and flood the surrounding tissue with inflammatory mediators, pro-apoptotic factors, and matrix degrading proteases. These actions can result in inflammation that can dismantle tissues to the point of inflicting serious injury. Tissue destruction perpetrated by macrophage-induced inflammation, a form of immune system dysregulation, is associated with the progression of ALS.

Oxidative agents such as chlorite can return macrophages to the inactivated state. Chlorite can be used to treat various diseases or conditions where immune system dysregulation is implicated in disease pathology. A pharmaceutical composition comprising sodium chlorite can comprise an IV formulation of pH-adjusted purified sodium chlorite, which can be converted into taurine chloramine in vivo, for example, in a subject's body. Taurine chloramine is a known regulator of NFkB activation. Chloramine levels in macrophages increase rapidly and remain elevated in vitro.

ALS subjects can be defined by four generalized patient groups; slowly progressive, fast progressive, early disease presentation, and late disease presentation. Of the four categories, only the slowly progressive group includes inflammation as a significant aspect of ALS disease pathology. The slowly progressive subsets' association with inflammation is inferred upon study of ALS in association with C-reactive protein (CRP) levels over time from diagnosis. The longer an ALS patient lives after diagnosis, the higher the plasma CRP. A large subgroup of ALS patients is evidence for ongoing, and potentially growing, inflammation associated with a slower rate of progression.

ALS can also be distinguished by ALS symptoms, genetic cause, lack of clear genetic association, or combinations thereof. In comes embodiments, subjects with ALS can be categorized as sporadic or inherited ALS. Sporadic ALS pathology occurs in subjects with no genetic or family history of ALS, while inherited ALS pathology occurs in subjects with a genetic or family history of ALS. As many as 90% to 95% of ALS cases can be sporadic and occur in subjects with no genetic or family history of ALS.

A subject for therapy with a formulation herein can be an animal. In some embodiments, the subject can be a mammal. In some embodiments, the subject can be a human.

In some embodiments, the subject can be a human, with ALS at any stage. The subject can exhibit a CRP level of, for example, greater than 1.13 mg/L. The subject can have an age of, for example, at least about 20, at least about 25, at least about 30, at least about 35, at least about 40, at least about 45, at least about 50, at least about 55, at least about 60, at least about 65, at least about 70, at least about 75, or at least about 80. The subject can have an age of, for example, no greater than about 20, no greater than about 25, no greater than about 30, no greater than about 35, no greater than about 40, no greater than about 45, no greater than about 50, no greater than about 55, no greater than about 60, no greater than about 65, no greater than about 70, no greater than about 75, or no greater than about 80. In some embodiments, the subject is age 25 to 80, 30 to 75, 35 to 70, 40 to 65, 45 to 60, 50 to 55, 20 to 65, 25 to 65, 30 to 65, 35 to 65, 40 to 65, 45 to 65, 50 to 65, or 60 to 65.

The chlorite ion is CO₂⁻. Chlorites can be salts of chlorous acid. Chlorine can assume oxidation states of −1, +1, +3, +5, or +7 within the corresponding anions Cl⁻, ClO⁻, ClO₂⁻, ClO₃⁻, or ClO₄⁻, known commonly and respectively as chloride, hypochlorite, chlorite, chlorate, and perchlorate.

A non-limiting example of a drug product containing sodium chlorite is a clear, colorless, sterile solution of sodium chlorite containing no preservatives. A non-limiting example contains purified sodium chlorite, sodium phosphate, dibasic and sterile water for injection, at a pH of 7.5 to 9.5. A non-limiting example uses high purity sodium chlorite. A non-limiting measure of purity of sodium chlorite in a sample is calculated as the percent weight of sodium chlorite to the total weight of the solvent-free sample. Purity can be evaluated using ion chromatography and an ion detector, by calibrated integration of the respective peaks; for example, chlorite, chloride, chlorate, phosphate, and sulfate in the compound or formulation. For example, sodium chlorite is commercially available as sodium chlorite, technical grade, at a purity of 80%. However, purification of sodium chlorite to a high purity level, e.g., at least 96%, is challenging. The present disclosure provides apparatuses and methods to provide such purity.

### Preparation and Purification of Chlorite Compounds

Described herein are apparatuses and methods of preparing and purifying sodium chlorite for use in pharmaceutical formulations, including, for example, a pharmaceutical composition comprising sodium chlorite. Disclosed are methods of sodium chlorite preparation/purification, methods of preparing sodium chlorite samples with the necessary purity and pH for use in pharmaceutical formulations, and pharmaceutical formulations comprising sodium chlorite.

### Apparatus for Chlorite Purification

Sodium chlorite is extremely reactive and may explode in a violent reaction upon contact with organic substances including gloves, clothing, spillage control materials such as sawdust and cotton waste, or oil and grease. The purification of sodium chlorite can involve an apparatus that is corrosion resistant, heat resistant, and substantially free of any potential substances that can rigorously react with sodium chlorite.

The present disclosure provides an apparatus that can be used for safe and efficient production and purification of sodium chlorite. As recrystallization and filtration can be performed in the same contained system, the apparatus can minimize work exposure and limit losses due to multiple transfers.

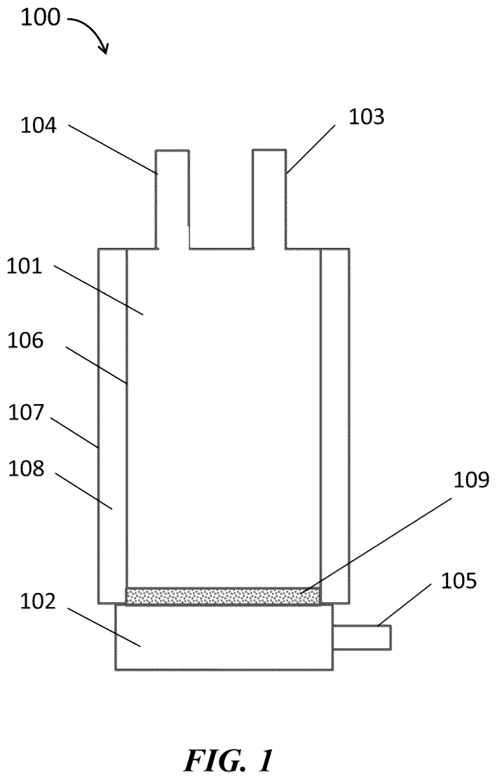

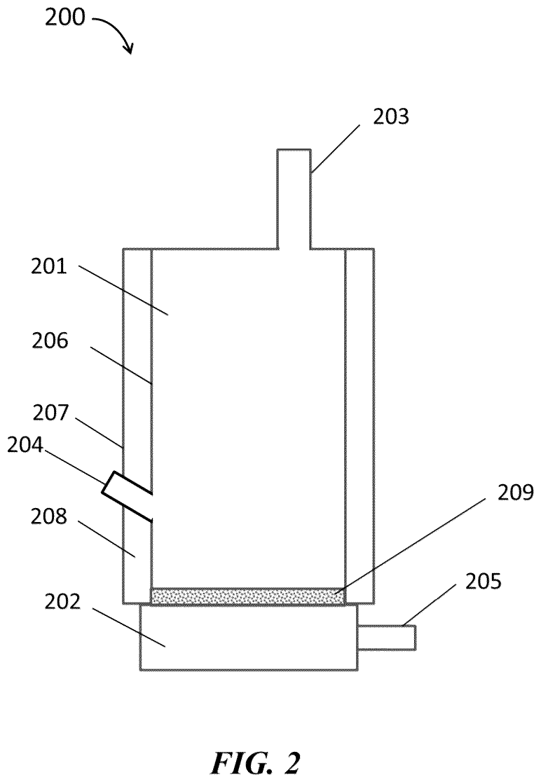

FIGS. 1 and 2 show examples of apparatuses for purification of sodium chlorite. In FIG. 1, the apparatus 100 can comprise a glass chamber 101, an access port 103, and a filter 109. In FIG. 2, the apparatus 200 can comprise a glass chamber 201, an access port 203, and a filter 209. The glass chamber 101 or 201 can be double-walled, with an inner wall 106 or 206 and an outer wall 107 or 207. The gap 108 or 208 between the inner wall and out wall can be kept under vacuum or filled with an inert gas. The glass chamber 101 or 201 can be configured to be airtight.

In some embodiments, the glass chamber can comprise borosilicate glass, lime glass, or soda-lime glass. In some embodiments, the glass chamber can comprise type 1 class A borosilicate glass.

The glass chamber 101 or 201 can be substantially free of any or all of air, metal, acid, and organic chemicals.

The glass chamber 101 or 201 can further comprise a bottom 102 or 202, configured to collect a liquid passing through the filter 109 or 209. The bottom 102 or 202 can further comprise an exit port 105 or 205 connected to the bottom 102 or 202.

The access port 103 or 203 is attached to the glass chamber 101 or 201. The access port can allow the deposition of a substrate into the chamber. The access port forms an air-tight seal when the access port is closed. The access port can also allow insertion of a sample tool into the glass chamber from outside the glass chamber when the access port is open.

In some embodiments, the glass chamber can comprise an additional access port. In some embodiments, the additional access port 104 can be at the top of the glass chamber 101 (see FIG. 1). In some embodiments, the additional access port 204 can be at the side wall of the glass chamber 201 (see FIG. 2).

In some embodiments, the deposition of substrate and sampling can be done through different access ports.

In some embodiments, the additional access port 104 or 204 can comprise an insertion for a temperature sensor, or a temperature sensor probe.

The filter 109 or 209 at the bottom of the chamber can be corrosion resistant and resistant to chemical reactivity with sodium chlorite. The filter 109 or 209 can comprise plastic material. In some embodiments, the filter 109 or 209 can comprise a fluorinated plastic material. Non-limiting examples of fluorinated plastic material include polytetrafluoroethylene (PTFE), poly(chlorotrifluoroethylene) (PCTFE), ethylene-tetrafluoroethylene copolymer (ETFE), poly(vinyl fluoride) (PVF), poly(vinylidene fluoride) (PVDF), tetrafluoroethylene-hexafluoropropylene (FEP), and perfluoroalkoxy (PFA). In some embodiments, the filter 109 or 209 can comprise PTFE. In some embodiments, the filter 109 or 209 can comprise plastic coated aluminum. In some embodiments, the filter 109 can comprise PTFE coated aluminum.

The apparatus can further comprise a temperature-regulating element, wherein the temperature-regulating element is in contact with the glass chamber such that the temperature-regulating element is disposed to regulate temperature within the glass chamber.

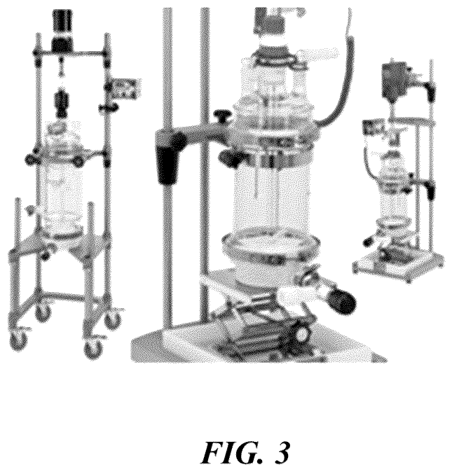

In some embodiments, the glass chamber can have a volume of at least about 1 liter, at least about 2 liters, at least about 3 liters, at least about 4 liters, at least about 5 liters, at least about 10 liters, at least about 15 liters, at least about 20 liters, at least about 25 liters, at least about 30 liters, at least about 35 liters, at least about 40 liters, at least about 45 liters, at least about 50 liters, at least about 55 liters, at least about 60 liters, at least about 65 liters, at least about 70 liters, at least about 75 liters, at least about 80 liters, at least about 85 liters, at least about 90 liters, at least about 95 liters, at least about 100 liters, at least about 200 liters, at least about 300 liters, at least about 400 liters, at least about 500 liters, or more. FIG. 3 shows examples of apparatuses with different sizes and dimensions. The apparatus is scalable to be used in lab scale, pilot scale, or commercial production scale.

In some embodiments, the glass chamber and the bottom can be removably coupled. In some embodiments, the glass chamber and the bottom can be a single, self-contained apparatus.

In some embodiments, the apparatus comprises (i) a glass chamber, wherein the glass chamber is double-walled, airtight, substantially free of air, substantially free of metal, substantially free of acid, and substantially free of organic chemicals, wherein the glass chamber comprises a bottom; and wherein the glass chamber has a volume of at least one liter; (ii) an access port attached to the glass chamber, wherein the access port is configured to allow insertion of a sample tool into the glass chamber from outside the glass chamber when the access port is open; and the access port forms an air-tight seal when the access port is closed; (iii) a filter inside the glass chamber at the bottom of the glass chamber, wherein the filter is corrosion resistant; and the filter is resistant to chemical reactivity with sodium chlorite; and (iv) a temperature-regulating element, wherein the temperature-regulating element is in contact with the glass chamber such that the temperature-regulating element is disposed to regulate temperature within the glass chamber.

In some embodiments, the access port is configured to allow insertion of a sample tool into the glass chamber from outside the glass chamber when the access port is open. In some embodiments. In some embodiments, the access port forms an air-tight seal when the access port is closed.

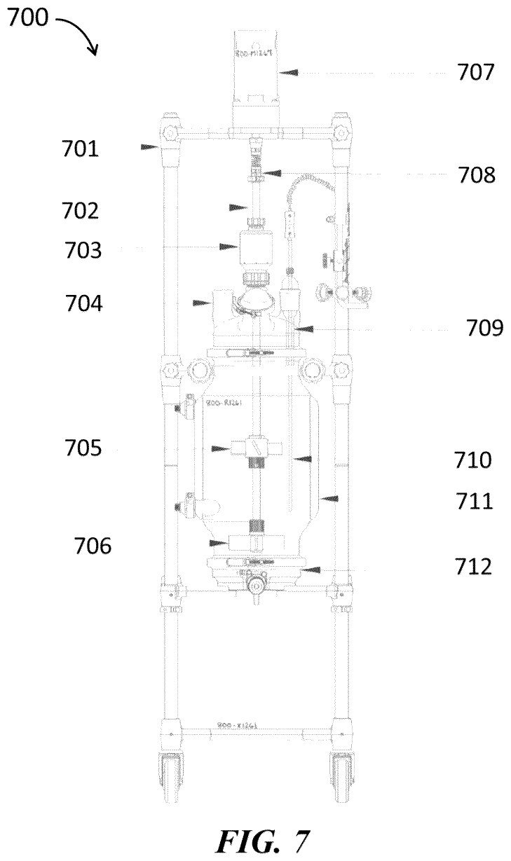

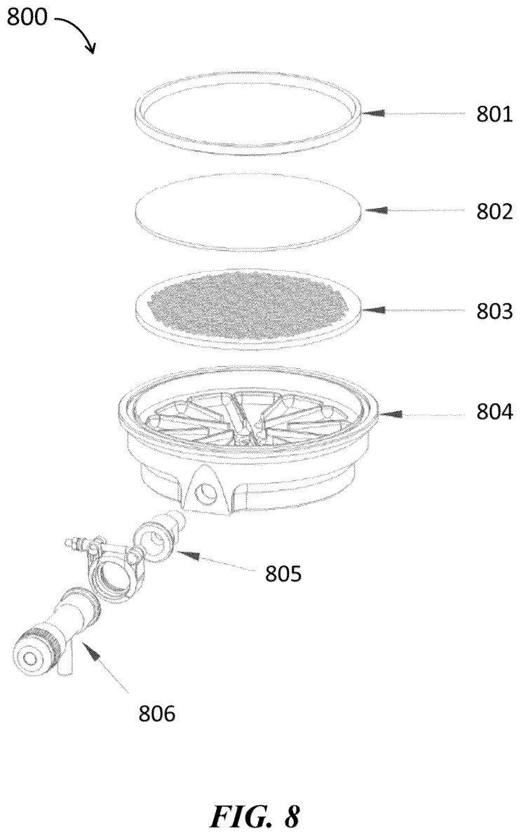

FIG. 7 shows a non-limiting example of a reactor for sodium chlorite purification. The reactor 700 comprises a reaction vessel 711, a port 704, a filter support assembly 712 (details shown in FIG. 8), and a thermocouple 710 to measure the temperature inside the vessel or in the solution. The port 704 is sealed during the purification process.

The reactor 700 further comprises a support stand 701, a stirring shaft 702 to drive the agitation, mechanical seal bearings 703 to ensure the sealing between the stirring shaft and the vessel M, an agitator 705 (e.g., 5″, 60° angle), an additional agitator 706 (e.g., 5.5″, square shape), a motor 707 (digital or electrical), stirrer coupling assembly 708, and a thermocouple adaptor 709.

FIG. 8 shows a non-limiting example of a filter support assembly. The assembly 800 comprises a hold-down ring 801, a Teflon filter 802 (5, 30, or 50 micron), a perforated support plate 803, a filter base with side port 804, a drain adaptor 805, and a drain valve 806.

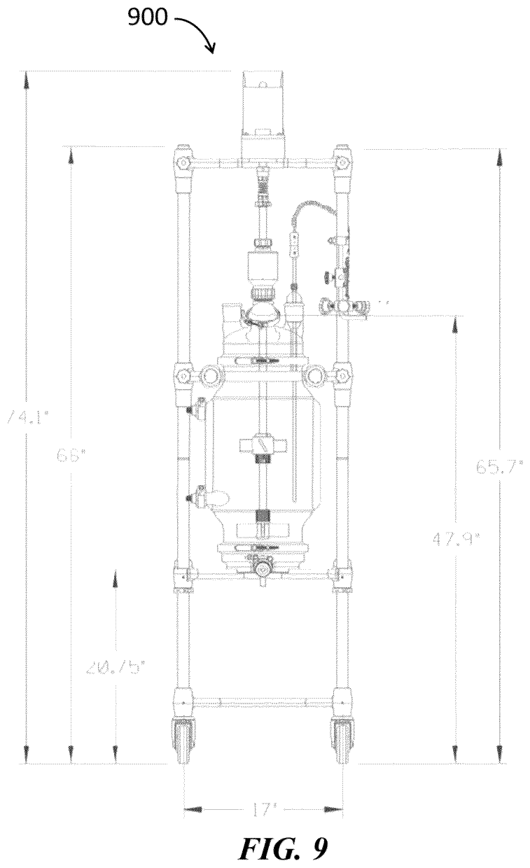

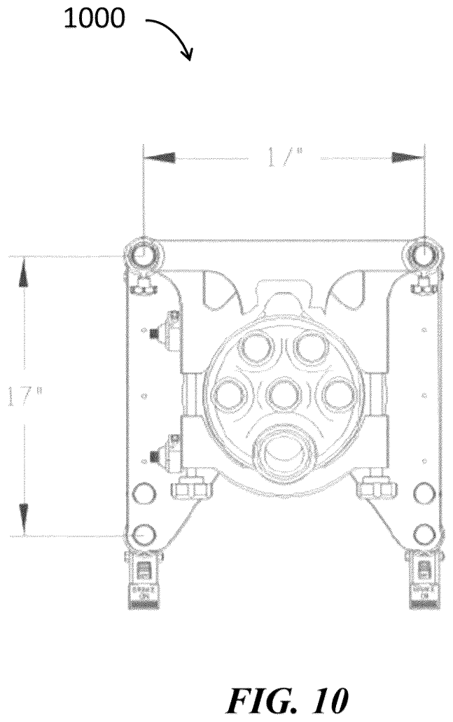

FIG. 9 shows a non-limiting example of a reactor. For example, the reactor 900 has a height of about 74.1″, a width of about 17″, and a stand height of about 66″. FIG. 10 shows a section view of a reactor 1000 having a length of about 17″ and a width of about 17″.

### Methods of Preparation/Purification

Described herein are methods of purifying sodium chlorite and producing pharmaceutical formulations described herein.

In some embodiments of any methods of the present disclosure, impure sodium chlorite is between about 0.1% and about 99% per weight of the starting material, e.g., crude sodium chlorite. As non-limiting examples of the purity of the crude sodium chlorite, sodium chlorite is between about 0.1% and about 5%; between about 1% and about 5%; between about 4% and about 10%; between about 1% and about 15%; between about 15% and about 25%; between about 5% and about 25%; between about 25% and about 50%; between about 50% and about 75%; between about 75% and about 85%; between about 85% and about 95%; between about 60% and about 90%; at least or greater than about 50%, at least or greater than about 60%, at least or greater than about 70%, at least or greater than about 80%, at least or greater than about 90%, or at least or greater than about 95% pure. If the crude sodium chlorite is in a solvent, the percent purity is relative to the non-solvent components. In some embodiments, the crude sodium chlorite is between about 75% and about 85% pure. In some embodiments, the crude sodium chlorite is between about 85% and about 95% pure. In some embodiments, the crude sodium chlorite is at least or greater than about 80% pure. In some embodiments, the crude sodium chlorite is up to about 80% pure. In some embodiments, the crude sodium chlorite is about 75% to about 85% pure. In some embodiments, the crude sodium chlorite is about 78% to about 82% pure. In some embodiments, the crude sodium chlorite is about 79% to about 81% pure. In some embodiments, the crude sodium chlorite is about 80% pure. The impurities in the crude sodium chlorite can comprise chlorate, sulfate, chlorine dioxide, chloride, sodium bicarbonate, or sodium carbonate ions.

In some embodiments, the purification is by contacting crude sodium chlorite with a liquid, thereby generating a sodium chlorite mixture and obtaining purified sodium chlorite from the sodium chlorite mixture, wherein the purified sodium chlorite has a purity of at least 96%.

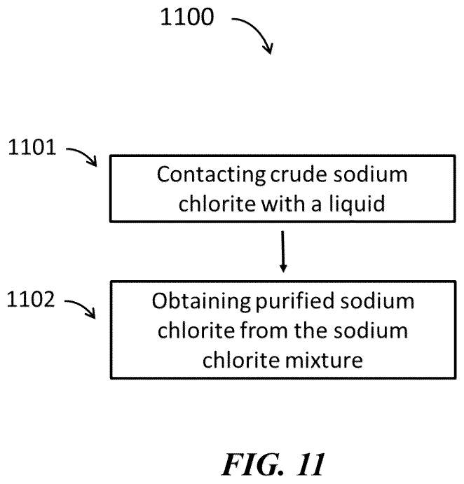

FIG. 11 illustrates a non-limiting example of the purification method 1100.

At operation 1101, the purification method 1100 comprises contacting crude sodium chlorite with a liquid, thereby generating a sodium chlorite mixture. In some embodiments, the liquid comprises an aqueous solution. In some embodiments, the liquid comprises water. In some embodiments, the liquid comprises pharma water. In some embodiments, the liquid comprises water for injection (WFI), for example, water used for the manufacturing of pharmaceutical products that are administered parenterally, ophthalmically, or inhaled. In some embodiments, the contacting can be performed under an inert environment (e.g., nitrogen or argon). In some embodiments, the mass ratio of the liquid to the crude sodium chlorite can be from about 0.4 to about 1.2, from about 0.5 to about 1.2, from about 0.6 to about 1.2, from about 0.7 to about 1.2, from about 0.75 to about 1.2, from about 0.8 to about 1.2, from about 0.9 to about 1.2, or from about 1 to about 1.2. In some embodiments, the contacting can comprise contacting at least about 100 g, at least about 200 g, at least about 300 g, at least about 400 g, at least about 500 g, at least about 600 g, at least about 700 g, at least about 800 g, at least about 900 g, at least about 1000 g, at least about 1100 g, at least about 1200 g, at least about 1300 g, at least about 1400 g, at least about 1500 g, at least about 1600 g, at least about 1700 g, at least about 1800 g, at least about 1900 g, at least about 2000 g, at least about 2500 g, at least about 3000 g, at least about 3500 g, at least about 4000 g, at least about 4500 g, at least about 5000 g, at least 10 kg, at least 50 kg, at least 100 kg, at least 200 kg, at least 500 kg, at least 1000 kg, or more of crude sodium chlorite with the liquid.

In some embodiments, the contacting can be performed with agitation of the sodium chlorite mixture. In some embodiments, the contacting can be performed at elevated temperatures. In some embodiments, the contacting can be performed at a temperature from about 50° C. to about 100° C., from about 60° C. to about 100° C., from about 70° C. to about 100° C., from about 75° C. to about 100° C., from about 80° C. to about 100° C., or from about 90° C. to about 100° C. In some embodiments, the contacting is performed at about 70° C. In some embodiments, the contacting is performed at a temperature from about 65° C. to about 75° C. In some embodiments, the mixture can be heated at a heating rate of from about 0.1 to about 0.5° C./min, from about 0.1 to about 1° C./min, from about 0.1 to about 2° C./min, from about 0.1 to about 5° C./min, from about 0.1 to about 10° C./min, from about 0.5 to about 10° C./min, from about 1 to about 10° C./min, from about 2 to about 10° C./min, or from about 5 to about 10° C./min.

In some embodiments, the contacting the crude sodium chlorite with the liquid comprises substantially dissolving the crude sodium chlorite in the liquid. In some embodiments, the method can further comprise, subsequent to the contacting, filtering the mixture. In some embodiments, the filtering can be performed by passing the mixture through a filter. In some embodiments, the filter can have a pore size of 0.1 to 1 micron. In some embodiments, the filter can have a pore size of about 0.2 micron. In some embodiments, the filter comprises a 0.2 micro cartridge filter. In some embodiments, the filtering can be performed by passing the mixture through a 0.2 micro cartridge filter. In some embodiments, the mixture is filtered to a chamber. In some embodiments, the chamber can be any glass chamber that is disclosed in this application, e.g., the glass chamber disclosed in FIGS. 1-3, 7, and 9. In some embodiments, the chamber is airtight and is substantially free of air, metal, acid, and organic chemicals.

At operation 1102, the purification method 1100 comprises obtaining purified sodium chlorite from the sodium chlorite mixture.

In some embodiments, the obtaining the purified sodium chlorite from the sodium chlorite mixture comprises crystallizing the purified sodium chlorite from the sodium chlorite mixture. In some embodiments, crystallizing the purified sodium chlorite from the sodium chlorite mixture comprises freezing the sodium chlorite mixture to provide a frozen sodium chlorite mixture, then heating the frozen sodium chlorite mixture. In some embodiments, the freezing can comprise cooling the mixture to a temperature that is below the freezing point of the mixture. In some embodiments, the temperature can be from about −30° C. to about −20° C., from about −30° C. to about −10° C., from about −25° C. to about −10° C., from about −25° C. to about −15° C., from about −20° C. to about −10° C. In some embodiments, the temperature is about −20° C. In some embodiments, the mixture can be cooled at a cooling rate from about 0.01 to about 0.1° C./min, from about 0.01 to about 0.2° C./min, from about 0.01 to about 0.5° C./min, from about 0.01 to about 1° C./min, from about 0.01 to about 2° C./min, from about 0.01 to about 5° C./min, or from about 0.01 to about 10° C./min. In some embodiments, the mixture can be cooled over a period of from 30 min to 10 hours. In some embodiments, the mixture can be held at the temperature for a period of from 1 hour to 24 hours.

In some embodiments, the crystallizing can comprise, subsequent to freezing, heating the frozen sodium chlorite mixture. In some embodiments, the mixture can be heated to a temperature from about 5 to about 10° C. from about 5 to about 15° C., from about 5 to about 20° C., from about 5 to about 25° C., from about 5 to about 30° C., or from about 5 to about 40° C.) In some embodiments, the frozen sodium chlorite mixture can be heated to about 10° C. In some embodiments, the heating can be performed at a heating rate from about 0.01 to about 0.1° C./min, from about 0.01 to about 0.2° C./min, from about 0.01 to about 0.5° C./min, from about 0.01 to about 1° C./min, from about 0.01 to about 2° C./min, from about 0.01 to about 5° C./min, or from about 0.01 to about 10° C./min. In some embodiments, the heating can be performed over a period of from 30 min to 10 hours. In some embodiments, the mixture can be held at the heated temperature for a period of from 1 hour to 24 hours.

In some embodiments, sodium chlorite crystallizes following the heating process, thereby generating a mixture of a solid phase comprising sodium chlorite and a liquid phase from the frozen sodium chlorite mixture.

In some embodiments, the solid phase comprises crystalline sodium chlorite. In some embodiments, the purification method 1100 further comprises separating the solid phase and the liquid phase. In some embodiments, the separating comprises removing the liquid phase from the solid phase. In some embodiments, the separation is performed by filtration. In some embodiments, the separation is performed under vacuum.

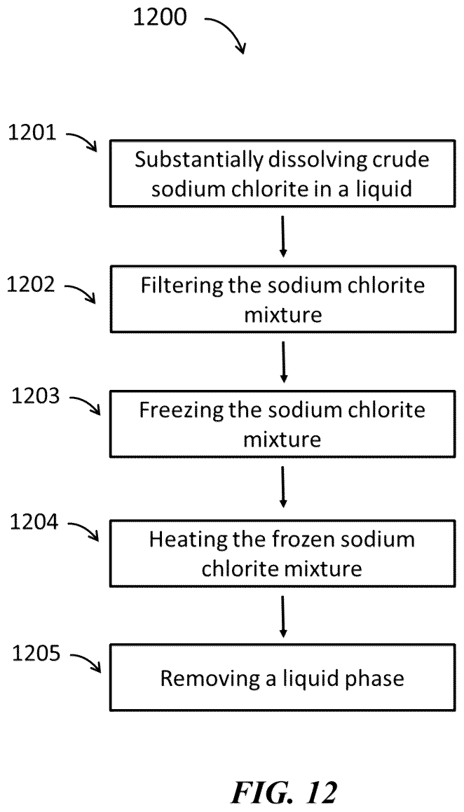

FIG. 12 illustrates another non-limiting example of purification method 1200. The method 1200 comprises a) substantially dissolving crude sodium chlorite in a liquid (operation 1201), b) filtering the sodium chlorite mixture (operation 1202); c) freezing the sodium chlorite mixture (operation 1203); d) heating the frozen sodium chlorite mixture (operation 1204); and e) removing the liquid phase (operation 1205). In some embodiments, the dissolving is performed at a temperature from about 50° C. to about 100° C. In some embodiment, the filtering comprises passing the sodium chlorite mixture through a filter to a glass chamber, wherein the glass chamber is airtight and is substantially free of air, metal, acid, and organic chemicals. In some embodiments, freezing the sodium chlorite mixture generates a frozen sodium chlorite mixture. In some embodiments, heating the frozen sodium chlorite mixture generates a mixture of a solid phase and a liquid phase. In some embodiments, the solid phase comprises crystalline sodium chlorite. In some embodiments, removing the liquid phase comprises separating the solid phase and the liquid phase.

In some embodiments, the method comprises: a) substantially dissolving crude sodium chlorite in a liquid at a temperature from about 50° C. to 100° C. with agitation thereby generating a sodium chlorite mixture, wherein the crude sodium chlorite is up to about 80% pure, wherein the liquid comprises water, b) passing the sodium chlorite mixture through a filter to a glass chamber, wherein the glass chamber is airtight and is substantially free of air, metal, acid, and organic chemicals; c) freezing the sodium chlorite mixture in the glass chamber to provide a frozen sodium chlorite mixture; d) heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; and e) separating the solid phase from the liquid phase by filtration, wherein the solid phase comprises crystalline sodium chlorite.

In some embodiments, the liquid comprises water. In some embodiments, the liquid comprises pharma water. In some embodiments, the liquid comprises water for injection. In some embodiments, the crude sodium chlorite has a mass of at least about 100 g, at least about 200 g, at least about 300 g, at least about 400 g, at least about 500 g, at least about 600 g, at least about 700 g, at least about 800 g, at least about 900 g, at least about 1000 g, at least about 1100 g, at least about 1200 g, at least about 1300 g, at least about 1400 g, at least about 1500 g, at least about 1600 g, at least about 1700 g, at least about 1800 g, at least about 1900 g, at least about 2000 g, at least about 2500 g, at least about 3000 g, at least about 3500 g, at least about 4000 g, at least about 4500 g, at least about 5000 g, or more.

In some embodiment, the dissolving is performed at a temperature from about 70° C. In some embodiments, the filter is a 0.2 micro cartridge filter.

In some embodiments, heating the frozen sodium chlorite mixture comprises heating the frozen sodium chlorite mixture to about 10° C.

In some embodiments, the purification method, e.g., method 1100 or 1200, further comprises measuring a purity of the sodium chlorite. If the purity meets a threshold purity value, the purification method e.g., method 1100 or 1200, can further comprise collecting the sodium chlorite. In some embodiments, the purified sodium chlorite can be further processed and/or packaged. If the purity does not meet the threshold purity value, the purification method, e.g., method 1100 or 1200, can further comprise dissolving the purified sodium chlorite in a solvent and recrystallizing the purified sodium chlorite from the solvent.

In some embodiments, the threshold purity value can be at least 96% pure, at least 96.5% pure, at least 97% pure, at least 97.5% pure, at least 98% pure, at least 98.5% pure, at least 99% pure, or more.

In some embodiments, the purification method, e.g., method 1100 or 1200, can comprise at least one cycle of the dissolving and recrystallization. In some embodiments, the method, e.g., method 1100 or 1200, can comprise at least two cycles of the dissolving and recrystallization. In some embodiments, the method, e.g., method 1100 or 1200, can comprise at least three cycles of the dissolving and recrystallization.

In some embodiments, the purified sodium chlorite is in an amount of at least about 500 g. at least about 1000 g, at least about 1500 g, at least about 2000 g, at least about 2500 g, at least about 3000 g, at least about 3500 g, at least about 4000 g, at least about 4500 g, at least about 5000 g. or more.

In some embodiments, the purification method, e.g., method 1100 or 1200, further comprises transferring the purified sodium chlorite to a container. In some embodiments, the purification method further comprises dissolving the purified sodium chlorite in water. In some embodiments, the dissolved sodium chlorite is in water at a level of about 100 mg/mL to about 125 mg/mL. In some embodiments, the transferring is performed before the dissolving. In some embodiments, the transferring is performed after the dissolving.

In some embodiments, the purification method 1100 or 1200 further comprises processing the purified sodium chlorite into a plurality of unit dosage forms, wherein each unit dosage form comprises sodium chlorite dissolved in phosphate buffer at a pH of about 7 to about 11.

In some embodiments, the purification method 1100 or 1200 further comprises packaging the plurality of unit dosage forms into pharmaceutically-acceptable packaging.

In some embodiments, the present disclosure provides a method of purifying sodium chlorite, the method comprising: a) depositing crude sodium chlorite and a liquid in a chamber; and b) recrystallizing the crude sodium chlorite in the chamber to provide purified sodium chlorite.

In some embodiments, the purification is by heating a mixture comprising crude sodium chlorite to a molten state, following by a recrystallization of the sodium chlorite and separation of the recrystallized sodium chlorite from the remaining mixture by filtration.

In some embodiments, the present disclosure provides a method of purifying sodium chlorite, the method comprising: a) depositing crude sodium chlorite in a chamber; and b) recrystallizing the crude sodium chlorite in the chamber to provide purified sodium chlorite. In some embodiments, the present disclosure provides a method of purifying sodium chlorite, the method comprising: a) depositing at least 1.5 kg crude sodium chlorite in a chamber; and b) recrystallizing the crude sodium chlorite in the chamber to provide at least 1 kg of purified sodium chlorite with a purity of at least 96%. The apparatus used for the purification of chlorite can be any suitable apparatus, for example, one disclosed elsewhere herein, e.g., an apparatus shown in any one of FIGS. 1-5, 7, and 9.

The crude sodium chlorite can be deposited into the glass chamber through the access port 103 (FIG. 1). Following the deposition of the crude sodium chlorite, the glass chamber can be sealed and evacuated by a vacuum pump to a pressure of, for example, from −400 mbar to −500 mbar. Alternatively, the glass chamber can be sealed and purged with an inert gas, e.g., argon or nitrogen.

In some embodiments, recrystallizing the crude sodium chlorite can comprise at least one cycle of heating the crude sodium chlorite to provide molten sodium chlorite, then cooling the molten sodium chlorite to a temperature at which the molten sodium chlorite recrystallizes. Heating the crude sodium chlorite can comprise heating the crude sodium chlorite to a temperature between 120° C. and 250° C. For example, heating the crude sodium chlorite can comprise heating the crude sodium chlorite to at least 120° C., at least 130° C., at least 140° C., at least 150° C., at least 160° C., at least 170° C., at least 180° C., at least 190° C., at least 200° C., at least 210° C., at least 220° C., at least 230° C., at least 240° C., or higher. Heating the crude sodium chlorite can comprise heating the crude sodium chlorite to at most 250° C., at most 245° C., at most 240° C., at most 235° C. at most 230° C., at most 225° C., at most 220° C., at most 215° C., at most 210° C., or lower. Any suitable and compatible heating element can be used herein for the heating, for example, a heating stage, coiled heating element, wire heating, or thick film heater. In some embodiments, the heating element can comprise a temperature-regulating element. In some embodiments, the temperature regulating element can regulate the temperature and/or the heating rate.

In some embodiments, the heating can last at least 30 min, at least 40 min, at least 50 min, at least 60 min, at least 70 min, at least 80 min, at least 90 min, at least 100 min, at least 110 min, at least 120 min, at least 130 min, at least 140 min, at least 150 min, at least 160 min, at least 170 min, at least 180 min, or more.

In some embodiments, the method comprises measuring a temperature of the chamber or the mixture. The measuring can be performed by a temperature sensor.

In some embodiments, the method can comprise monitoring a state of the mixture and sending an indication to the temperature-regulating element once the mixture reaches a desired molten state. The temperature-regulating element can cease the heating upon receiving the indication. In some embodiments, the monitoring can be performed by a sensor. e.g., an image sensor or an Infrared sensor.

Subsequent to heating and melting the mixture to the molten state, the temperature can be lowered to allow for recrystallization of the molten sodium chlorite. In some embodiments, the temperature at which the molten sodium chlorite recrystallizes is not higher than 80° C. not higher than 70° C. not higher than 60° C. not higher than 50° C. or not higher than 40° C.

In some embodiments, the method can further comprise holding the molten sodium chlorite at the temperature at which the molten sodium chlorite recrystallizes until the molten sodium chlorite recrystallizes to provide a recrystallized sodium chlorite. The holding can be at least 30 min. at least 40 min, at least 50 min, at least 60 min. at least 70 min. at least 80 min. at least 90 min. at least 100 min. at least 110 min. at least 120 min, at least 130 min. at least 140 min. at least 150 min. at least 160 min. at least 170 min. at least 180 min. or more.

In some embodiments, the method can comprise monitoring a state of the recrystallization and sending an indication to a user or an operator once the recrystallization reaches a desired level. In some embodiments, the monitoring can be performed by a sensor, e.g., an image sensor or an Infrared sensor.

After the recrystallization, the mixture can comprise recrystallized sodium chlorite and non-recrystallized substances that are in non-crystalline, for example, liquid form. In some embodiments, the method can further comprise subjecting the reacted mixture to filtration, thereby providing the purified sodium chlorite.

The method can further comprise collecting a sample of the purified sodium chlorite via a sampling port of the chamber for testing. The collecting can comprise inserting a sample tool through the access port a sampling tool, collecting by the sample tool a sample of the recrystallized sodium chlorite, and withdrawing the sample of the recrystallized sodium chlorite through the access port. The testing can comprise performing an assay on the sample of the recrystallized sodium chlorite to determine a level of purity of the sample.

If the purity does not reach a desired level, for example, at least 96%, the method can comprise subjecting the purified sodium chlorite to additional recrystallization.

In some embodiments, recrystallizing the crude sodium chlorite can comprise at least two cycles of heating the crude sodium chlorite to provide molten sodium chlorite, then cooling the molten sodium chlorite to a temperature at which the molten sodium chlorite recrystallizes, then holding the molten sodium chlorite at the temperature at which the molten sodium chlorite recrystallizes until the molten sodium chlorite recrystallizes to provide a recrystallized sodium chlorite, then subjecting the recrystallized sodium chlorite to filtration, thereby providing the purified sodium chlorite.

In some embodiments, recrystallizing the crude sodium chlorite can comprise at least three cycles of heating the crude sodium chlorite to provide molten sodium chlorite, then cooling the molten sodium chlorite to a temperature at which the molten sodium chlorite recrystallizes, then holding the molten sodium chlorite at the temperature at which the molten sodium chlorite recrystallizes until the molten sodium chlorite recrystallizes to provide a recrystallized sodium chlorite, then subjecting the recrystallized sodium chlorite to filtration, thereby providing the purified sodium chlorite.

In some embodiments, a method of purifying sodium chlorite can comprise: (a) depositing at least 1.5 kg crude sodium chlorite in a glass chamber that is airtight and is substantially free of air, metal, acid, and organic chemicals, wherein the crude sodium chlorite is about 80% pure; and b) recrystallizing the crude sodium chlorite in the glass chamber, wherein the recrystallizing the crude sodium chlorite comprises at least two cycles of heating the crude sodium chlorite to at least 120° C. to provide molten sodium chlorite, cooling the molten sodium chlorite to a temperature not higher than 70° C., holding the molten sodium chlorite at the temperature not higher than 70° C. until the molten sodium chlorite recrystallizes to provide a recrystallized sodium chlorite, then subjecting the recrystallized sodium chlorite to filtration, thereby providing at least 1 kg of purified sodium chlorite with a purity of at least 96%; and c) removing at least 1 kg of the purified sodium chlorite from the glass chamber.

In some embodiments, a method of purifying sodium chlorite can comprise: a) depositing at least 1.5 kg crude sodium chlorite in a glass chamber, wherein the glass chamber is double-walled, airtight, and substantially free of air, metal, acid, and organic chemicals, and the glass chamber comprises a bottom, and (b) recrystallizing the crude sodium chlorite in the glass chamber to provide at least 1 kg of purified sodium chlorite with a purity of at least 96%. In some embodiments, recrystallizing the crude sodium chlorite can comprise at least one, at least two, or at least three cycles of heating the crude sodium chlorite by the temperature-regulating element to provide molten sodium chlorite, then cooling the molten sodium chlorite to a temperature at which the molten sodium chlorite recrystallizes, then holding the molten sodium chlorite at the temperature at which the molten sodium chlorite recrystallizes until the molten sodium chlorite recrystallizes to provide a recrystallized sodium chlorite, then subjecting the recrystallized sodium chlorite to filtration through the filter, thereby providing the purified sodium chlorite.

In some embodiments, the method can further comprise removing at least 1 kg of the purified sodium chlorite from the glass chamber. In some embodiments, the method can further comprise dissolving at least 1 kg of the purified sodium chlorite in water at a level of about 100 mg/mL to about 125 mg/mL. In some embodiments, the method can further comprise dissolving at least 1 kg of the purified sodium chlorite in phosphate buffer. In some embodiments, the method can further comprise processing at least 1 kg of the purified sodium chlorite into a plurality of unit dosage forms, wherein each unit dosage form comprises sodium chlorite dissolved in phosphate buffer at a pH of about 7 to about 11. In some embodiments, the method can further comprise packaging the plurality of unit dosage forms into pharmaceutically-acceptable packaging.

In some embodiments, the method can further comprise removing the purified sodium chlorite from the chamber. In some embodiments, the method can further comprise removing at least 1 kg of the purified sodium chlorite from the chamber. The purified sodium chlorite can be removed from an exit port from the chamber. The removing can be performed in an inert environment, e.g., inside a glove box or under a purge flow of inert gas.

In some embodiments, the purified sodium chlorite is substantially anhydrous.

Due to the reactivity of sodium chlorite, the solid sodium chlorite can be dissolved in water or a buffer solution for safe storage, transport, and handling.

In some embodiments, the purified sodium chlorite can contain sufficient water to render the purified sodium chlorite non-incendiary. In some embodiments, the method can further comprise dissolving the purified sodium chlorite in water. In some embodiments, the method can further comprise dissolving the purified sodium chlorite in water at a level of about 100 mg/mL to about 125 mg/mL. In some embodiments, the method can further comprise dissolving at least 1 kg of the purified sodium chlorite in water at a level of about 100 mg/mL to about 125 mg/mL.

In some embodiments, the method can further comprise dissolving the purified sodium chlorite in phosphate buffer. In some embodiments, the method can further comprise dissolving at least 1 kg of the purified sodium chlorite in phosphate buffer.

In some embodiments, the method can further comprise processing the purified sodium chlorite into a plurality of unit dosage forms, wherein each unit dosage form comprises sodium chlorite dissolved in phosphate buffer at a pH of about 7 to about 11. In some embodiments, the method can further comprise processing at least 1 kg of the purified sodium chlorite into a plurality of unit dosage forms, wherein each unit dosage form comprises sodium chlorite dissolved in phosphate buffer at a pH of about 7 to about 11.

In some embodiments, the method can further comprise packaging the plurality of unit dosage forms into pharmaceutically-acceptable packaging, e.g., a pharmaceutically-acceptable container. The pharmaceutically-acceptable packaging can comprise any suitable packaging or container that is compatible with the solid sodium chlorite or the sodium chlorite solution. The pharmaceutically-acceptable packaging can comprise primary packaging (or inner packaging) that is in direct contact with the solid sodium chlorite or the sodium chlorite solution. In some embodiments, the inner packaging can be substantially free of metal, acid, and organic chemicals.

Non-limiting examples of inner packaging material include glass, HDPE, PTFE, and metal coated with PTFE or HDPE. In some embodiments, the inner packaging material comprises glass. In some embodiments, the inner packaging material comprises HDPE.

In some embodiments, the pharmaceutically-acceptable packaging can further comprise secondary packaging (or outer packaging) that is not in direct contact with the solid sodium chlorite or the sodium chlorite solution. Non-limiting examples of outer packaging material include glass, plastic, metal, and ceramic. In some embodiments, the outer packaging material comprise HDPE. In some embodiments, the pharmaceutically-acceptable packaging can comprise materials that can reduce the amount of light which can reach the solid sodium chlorite or the sodium chlorite solution. In some embodiments, the pharmaceutically-acceptable packaging can further comprise a light barrier, for example, an aluminum overpouch or a carton. In some embodiments, the pharmaceutically-acceptable packaging can comprise a bag or a bottle. In some embodiments, the bag can be pre-mix bags or admix bags.

In some embodiments, the method can further comprise a sterilization procedure while packaging. Non-limiting examples of suitable sterilization procedures include terminal moist heat sterilization, ethylene oxide, radiation (i.e., gamma and electron beam), and aseptic processing techniques.

In some embodiments, the sterilization procedure can comprise using sterile materials and performing in a controlled working environment. In some embodiments, all containers and apparatus can be sterilized, e.g., by heat sterilization, prior to filling. In some embodiments, the container can be filled under aseptic conditions, such as by passing the composition, e.g., the solid sodium chlorite or sodium chlorite solution through a filter and filling the units.

In some embodiments, the sterilization procedure can comprise terminal sterilization. Terminal sterilization can destroy viable microorganisms within the final, sealed container or packaging. In some embodiments, terminal sterilization can comprise using moist heat. In some embodiments, terminal sterilization can comprise autoclave.

### Chlorite Compositions

Sodium chlorite with high purity can be produced from any of the methods provided herein. The sodium chlorite can be in a dry mode, e.g., anhydrous solid. The sodium chlorite can be in an aqueous solution. In some cases, the aqueous solution can comprise a phosphate buffer.

In some embodiments, the present disclosure provides a composition comprising solid sodium chlorite in a single portion of at least one kilogram (kg). In some embodiments, the solid sodium chlorite can have a purity of at least about 96%, at least about 97%, at least about 98%, at least about 99%, at least about 99.5%, at least about 99.9%, or higher.

In some embodiments, the single portion can be at least about 2 kg, at least about 5 kg, at least about 10 kg, at least about 20 kg, at least about 30 kg, at least about 40 kg, at least about 50 kg, at least about 60 kg, at least about 70 kg, at least about 80 kg, at least about 90 kg, at least about 100 kg, at least about 150 kg, at least about 200 kg, at least about 250 kg, at least about 300 kg, at least about 350 kg, at least about 400 kg, at least about 450 kg, at least about 500 kg, at least about 550 kg, at least about 600 kg, at least about 650 kg, at least about 700 kg, at least about 750 kg, at least about 800 kg, at least about 850 kg, at least about 900 kg, at least about 950 kg, at least about 1000 kg, at least about 1100 kg, at least about 1200 kg, at least about 1300 kg, at least about 1400 kg, at least about 1500 kg, at least about 1600 kg, at least about 1700 kg, at least about 1800 kg, at least about 1900 kg, at least about 2000 kg, or more.

In some embodiments, the composition can further comprise sodium chloride. In some embodiments, the sodium chloride can be at most about 4 weight percent (wt %), at most about 3.5 wt %, at most about 3 wt %, at most about 2.5 wt %, at most about 2 wt %, at most about 1.5 wt %, at most about 1 wt %, at most about 0.5 wt %, or less.

In some embodiments, the composition can further comprise sodium chlorate. In some embodiments, the sodium chlorate can be at most about 4 wt %, at most about 3.5 wt %, at most about 3 wt %, at most about 2.5 wt %, at most about 2 wt %, at most about 1.5 wt %, at most about 1 wt %, at most about 0.5 wt %, or less.

In some embodiments, the composition can further comprise sodium chlorate and sodium chloride. In some embodiments, the total amount of sodium chlorate and sodium chloride can be at most about 4 wt %, at most about 3.5 wt %, at most about 3 wt %, at most about 2.5 wt %, at most about 2 wt %, at most about 1.5 wt %, at most about 1 wt %, at most about 0.5 wt %, or less.

In some embodiments, the composition can be in a pharmaceutically-acceptable container.

In some embodiments, the present disclosure provides an article of manufacture comprising: a) an inner packaging material, wherein the inner packaging material is substantially free of acid, metal, and organic chemicals, wherein the inner packaging material is substantially airtight; b) an outer packaging material, wherein the outer packaging material is substantially opaque; and c) a sample of solid sodium chlorite in an amount of at least one kilogram and a purity of at least 96%.

The solid sodium chlorite is packaged in the inner packaging material such that the solid sodium chlorite is not exposed to acid, metal, and organic chemicals. The inner packaging material is packaged within the outer packaging material such that the solid sodium chlorite is not exposed to ambient light. In some embodiments, the solid sodium chlorite can be packaged in the inner packaging material under vacuum. In some embodiments, the solid sodium chlorite can be packaged in the inner packaging material under an inert gas.

In some embodiments, the solid sodium chlorite has a purity of at least about 97%, at least about 98%, at least about 99%, at least about 99.5%, at least about 99.9%, or higher.

In some embodiments, the sample of the solid sodium chlorite in the article of manufacture can be at least about 2 kg, at least about 5 kg, at least about 10 kg, at least about 20 kg, at least about 30 kg, at least about 40 kg, at least about 50 kg, at least about 60 kg, at least about 70 kg, at least about 80 kg, at least about 90 kg, at least about 100 kg, at least about 150 kg, at least about 200 kg, at least about 250 kg, at least about 300 kg, at least about 350 kg, at least about 400 kg, at least about 450 kg, at least about 500 kg, at least about 550 kg, at least about 600 kg, at least about 650 kg, at least about 700 kg, at least about 750 kg, at least about 800 kg, at least about 850 kg, at least about 900 kg, at least about 950 kg, at least about 1000 kg, at least about 1100 kg, at least about 1200 kg, at least about 1300 kg, at least about 1400 kg, at least about 1500 kg, at least about 1600 kg, at least about 1700 kg, at least about 1800 kg, at least about 1900 kg, at least about 2000 kg, or more.

In some embodiments, the sample of solid sodium chlorite in the article of manufacture can further comprise sodium chloride. In some embodiments, the sodium chloride is at most about 4 wt %, at most about 3.5 wt %, at most about 3 wt %, at most about 2.5 wt %, at most about 2 wt %, at most about 1.5 wt %, at most about 1 wt %, at most about 0.5 wt %, or less.

In some embodiments, the sample of solid sodium chlorite in the article of manufacture can further comprise sodium chlorate. In some embodiments, the sodium chlorate can be at most about 4 wt %, at most about 3.5 wt %, at most about 3 wt %, at most about 2.5 wt %, at most about 2 wt %, at most about 1.5 wt %, at most about 1 wt %, at most about 0.5 wt %, or less.

In some embodiments, the sample of solid sodium chlorite in the article of manufacture can comprise sodium chlorate and sodium chloride. In some embodiments, the total amount of sodium chlorate and sodium chloride can be at most about 4 wt %, at most about 3.5 wt %, at most about 3 wt %, at most about 2.5 wt %, at most about 2 wt %, at most about 1.5 wt %, at most about 1 wt %, at most about 0.5 wt %, or less.

In some embodiments, the inner packaging material of the article of manufacture is glass.

In some embodiments, the inner packaging material of the article of manufacture is HDPE.

In some embodiments, the outer packaging material of the article of manufacture is HDPE.

In some embodiments, the sample of solid sodium chlorite in the article of manufacture is in a pharmaceutically-acceptable container.

In some embodiments, the present disclosure provides a composition comprising: a) a solute in an amount of at least one kilogram, wherein at least 96% of the solute by mass is sodium ions and chlorite ions; and b) water, wherein the solute is dissolved in the water at a level of about 100 mg/mL to about 125 mg/mL.

In some embodiments, the present disclosure provides a composition comprising: a) a solute in an amount of at least one kilogram, wherein at least 96% of the solute by mass is sodium ions and chlorite ions; and b) phosphate buffer, wherein the solute is dissolved in the phosphate buffer. In some embodiments, the phosphate buffer can have a pH of about 7 to about 11, about 7 to about 9.5, about 7.5 to about 9, about 7.5 to about 8.5, or about 7.5 to about 8.

In some embodiments, the present disclosure provides an article of manufacture comprising a plurality of unit dosage forms, wherein each unit dosage form independently comprises: a) a solute, wherein at least 96% of the solute by mass is sodium ions and chlorite ions; and b) phosphate buffer, wherein the solute is dissolved in the phosphate buffer, wherein each unit dosage form independently has a pH of about 7 to about 11, wherein each unit dosage form is independently packaged in pharmaceutically-acceptable packaging, each providing a packaged dose; wherein the packaged doses are contained in a pharmaceutically-acceptable container; and wherein the amounts of the sodium ions and the chlorite ions in the unit dosage forms in the pharmaceutically-acceptable container sum to a total of at least 1 kilogram. In some embodiments, each unit dosage form independently can have a pH of about 7 to about 9.5, about 7.5 to about 9, about 7.5 to about 8.5, or about 7.5 to about 8.

In some embodiments, at least 97%, at least 98%, at least 99%, at least 99.5%, or more of the solute by mass is sodium ions and chlorite ions.

In some embodiments, the solute can be at least about 2 kg, at least about 5 kg, at least about 10 kg, at least about 20 kg, at least about 30 kg, at least about 40 kg, at least about 50 kg, at least about 60 kg, at least about 70 kg, at least about 80 kg, at least about 90 kg, at least about 100 kg, at least about 150 kg, at least about 200 kg, at least about 250 kg, at least about 300 kg, at least about 350 kg, at least about 400 kg, at least about 450 kg, at least about 500 kg, at least about 550 kg, at least about 600 kg, at least about 650 kg, at least about 700 kg, at least about 750 kg, at least about 800 kg, at least about 850 kg, at least about 900 kg, at least about 950 kg, at least about 1000 kg, at least about 1100 kg, at least about 1200 kg, at least about 1300 kg, at least about 1400 kg, at least about 1500 kg, at least about 1600 kg, at least about 1700 kg, at least about 1800 kg, at least about 1900 kg, at least about 2000 kg, or more.

In some embodiments, the solute can further comprise sodium chloride. In some embodiments, the sodium chloride can be at most 4 wt %, at most 3.5 wt %, at most 3 wt %, at most 2.5 wt %, at most 2 wt %, at most 1.5 wt %, at most 1 wt %, at most 0.5 wt %, or less.

In some embodiments, the solute can further comprise sodium chlorate. In some embodiments, the sodium chlorate can be at most 4 wt %, at most 3.5 wt %, at most 3 wt %, at most 2.5 wt %, at most 2 wt %, at most 1.5 wt %, at most 1 wt %, at most 0.5 wt %, or less.

In some embodiments, the solute can comprise sodium chlorate and sodium chloride. In some embodiments, the total amount of sodium chlorate and sodium chloride can be at most 4 wt %, at most 3.5 wt %, at most 3 wt %, at most 2.5 wt %, at most 2 wt %, at most 1.5 wt %, at most 1 wt %, at most 0.5 wt %, or less.

In some embodiments, the composition can be in a pharmaceutically-acceptable container.

### Chlorite Formulations and pH

Sodium chlorite can be formulated in aqueous solution in which the chlorite is greater than 96% pure. In some embodiments, the sodium chlorite can be greater than about 97%, greater than about 98%, greater than about 99%, greater than about 99.5% or greater than about 99.9% pure.

Alternatively, crystalline sodium chlorite is provided in a purity greater than about 96%, greater than about 97%, greater than about 98%, greater than about 99%, greater than about 99.5% or greater than about 99.9%. Solid pharmaceutical formulations comprising crystalline sodium chlorite in a purity greater than about 96%, greater than about 97%, greater than about 98%, greater than about 99%, greater than about 99.5% or greater than about 99.9% in addition to one or more pharmaceutical excipients are also encompassed.

The sodium chlorite formulations can comprise low amounts of, or be substantially free of, chlorate, sulfate or chloride ions. For example, in some embodiments, a sample or formulation can comprise no more than 1 part in 1000 by mass of non-solvent molecules in the formulation. In some embodiments, a mass ratio of chlorite ion to chlorate ion is greater than 100:1.5, greater than 100:0.5, greater than 100:1, or greater than 100:0.1. In some embodiments, the composition is substantially free of chlorate ion. In some embodiments, the mass ratio of chlorite ion to chloride ion is greater than 100:1.5, greater than 100:0.5, greater than 100:1, or greater than 100:0.1. In some embodiments, the composition is substantially free of chloride ion. In some embodiments, the mass ratio of chlorite ion to sulfate ion is greater than 100:1.5, greater than 100:0.5, greater than 100:1, or greater than 100:0.1. In some embodiments, the composition is substantially free of sulfate ion.

The pH of a sodium chlorite formulation can be adjusted to between about 7 and about 11. In some embodiments, the pH of a sodium chlorite formulation is adjusted to between about 7 and about 11 using a pH adjusting compound that does not expose the formulation to high local acidity. In some embodiments, the pH adjusting compound is any one or more of monosodium phosphate, disodium phosphate, or acetic acid.

In some embodiments, the disclosure uses aqueous formulations comprising sodium chlorite. In some embodiments, the sodium chlorite formulation comprises an aqueous solvent, and optionally one or more other solvents. In some embodiments, the formulations comprise sodium chlorite and an aqueous solvent, and have a pH of about 7 to about 11.

Solvents or combinations of solvents for use in the formulations described herein can be determined. One non-limiting example to determine a solvent system includes (1) theoretically estimating solvent solubility parameter value(s) and choosing the one(s) that match with sodium chlorite; (2) experimentally determining the saturation solubility of sodium chlorite in the solvent(s); (3) choosing one or more solvents that exhibit the desired solubility; and (4) selecting a solvent or solvents that do not diminish the activity of sodium chlorite, or that do not or only minimally react with sodium chlorite. In some embodiments, the liquid formulations described herein comprise a plurality of solvents.

In some embodiments, the sodium chlorite formulations comprise an aqueous solvent. In some embodiments, water is the principal solvent in the aqueous formulations. In some embodiments, water is at least or greater than about 50% by volume of the solvent component of an aqueous formulation. In some embodiments, water is at least or greater than about 50% by volume of the aqueous formulation. In some embodiments, water is any of between about 50 and about 60, between about 60 and about 70, between about 70 and about 80, between about 80 and about 90, between about 90 and about 99, at least or greater than about 50, at least or greater than about 60, at least or greater than about 70, at least or greater than about 80, at least or greater than about 90, or at least or greater than about 95, about 50, about 60, about 70, about 80, about 90, or about 95 percent by volume of the solvent component. In some embodiments, water is any of between about 50 and about 60, between about 60 and about 70, between about 70 and about 80, between about 80 and about 90, between about 90 to about 99, at least or greater than about 50, at least or greater than about 60, at least or greater than about 70, at least or greater than about 80, at least or greater than about 90, or at least or greater than about 95, percent by volume of the aqueous formulation. In some embodiments, water is at least or greater than about 95% by volume of the aqueous formulation. In some embodiments, water is between about 80 and about 90% by volume of the aqueous formulation. In some embodiments, water is between about 90 and about 99% by volume of the aqueous formulation. In some embodiments, water is substantially 100% of the solvent.

In some embodiments, the formulations have differing concentration of sodium chlorite. In some embodiments, the concentration in the formulation is high, and then is diluted to a less concentrated form prior to administration. In some embodiments, a formulation described herein is diluted about 2.5×, about 5×, about 7.5×, about 10×, about 20×, about 25×, about 50×, about 100×, about 200×, about 250×, about 300×, about 500×, or about 1000×. In some embodiments, a formulation described herein is diluted between about 2× and about 10×, between about 10× and about 50×, between about 50× and about 100×, between about 100× and about 500×, or between about 500× and about 1000×. In some embodiments, a formulation as described herein is diluted between about 2× and about 10×. In some embodiments, a formulation as described herein is diluted between about 10× and about 50×. In some embodiments, a formulation as described herein is diluted about 7.5×. In some embodiments, a formulation as described herein is diluted about 25×. In some embodiments, a formulation as described herein is diluted about 200×.

In some embodiments, the concentration of sodium chlorite in the formulations described herein is between about 1 μM and about 1.5 M. In some embodiments, the concentration of sodium chlorite in the formulations described herein is between about 1 M and about 1.5 M; between about 1 μM and about 100 mM; between about between about 10 μM and about 100 mM; between about 0.1 mM and about 10 mM; between about 0.1 mM and about 500 mM; between about 0.1 mM and about 200 mM; between about 1 mM and about 100 mM; between about 0.1 mM and about 5 mM; between about 50 mM and about 100 mM; between about 55 mM and about 70 mM; between about 60 mM and about 65 mM; between about 100 mM and about 500 mM; between about 200 mM and about 400 mM; between about 300 mM and about 700 mM; about 1 mM; about 1.5 mM; about 2 mM; about 2.5 mM; about 3 mM; about 3.5 mM; about 4 mM; about 5 mM; about 10 mM; about 20 mM; about 30 mM; about 40 mM; about 50 mM; about 60 mM; about 62 mM; about 65 mM; about 70 mM; about 80 mM; about 90 mM; about 100 mM; at least or greater than about 0.1 mM; at least or greater than about 1 mM; at least or greater than about 2 mM; at least or greater than about 5 mM; at least or greater than about 10 mM; at least or greater than about 20 mM; at least or greater than about 30 mM; at least or greater than about 40 mM; at least or greater than about 50 mM; at least or greater than about 60 mM; at least or greater than about 70 mM; at least or greater than about 80 mM; at least or greater than about 90 mM; or at least or greater than about 100 mM. In some embodiments, the concentration of sodium chlorite in the formulations described herein is about or at least or greater than about 60 mM.

In some embodiments, the concentration of sodium chlorate in the formulations described herein is between about 50 mM and about 100 mM. In some embodiments, the concentration of sodium chlorate in the formulations described herein is between about 55 mM and about 75 mM. In some embodiments, the concentration of sodium chlorate in the formulations described herein is between about 0.1 mM and about 10 mM. In some embodiments, the concentration of sodium chlorate in the formulations described herein is between about 1 mM and about 5 mM.

In some embodiments, the sodium chlorite formulation has a pH no greater than about 11.0. In some embodiments, the pH of the formulation is any of no greater than about 10.5, no greater than about 10.0, no greater than about 9.5, no greater than about 9.0, no greater than about 8.5, no greater than about 8.0, no greater than about 7.5, no greater than about 7.0, no greater than about 6.5, or no greater than about 6.0. In some embodiments, the pH of the formulation is no greater than about 11.0. In some embodiments, the pH of the formulation is between about 7 and about 11; between about 7 and about 10.5; between about 7 and about 10; between about 7 and about 9.5; between about 7 and about 9.0; between about 7 and about 8.5; between about 7 and about 8.0; between about 7 and about 7.5; between about 7.5 and about 8; between about 7.5 and about 8.5; between about 7 and about 8; between about 8 and about 9; between about 7.0 and about 8.5; between about 8 and about 8.5; between about 8.5 and about 9; between about 7.1 and about 7.7; between about 7.2 and about 7.6; between about 7.3 and about 7.4; about 7.0; about 7.1; about 7.2; about 7.3; about 7.4; about 7.5; about 7.6; about 7.7; about 7.8; about 7.9; about 8.0; about 8.1; about 8.2; about 8.3; about 8.4; about 8.5; about 8.6; about 8.7; about 8.8; or about 8.9. In some embodiments, the sodium chlorite formulation has a pH of about 7.0 to about 9.0. In some embodiments, the sodium chlorite formulation has a pH of about 7.0 to about 8.5. In some embodiments, the sodium chlorite formulation has a pH of about 6.0 to about 8.5. In some embodiments, the sodium chlorite formulation has a pH of about 7.0 to about 8.0. In some embodiments, the sodium chlorite formulation has a pH of about 7.4. The sodium chlorite formulation can have a pH that is at a physiological level.

In some embodiments, the chlorite formulations have a pH as described above, and are formulated for any one or more of parenteral, systemic, or intravenous administration. In some embodiments, the chlorite formulations have a pH as described above, and have a percentage chlorite purity as described herein.

In some embodiments, the formulations described herein have a pH as described above, and have a concentration of sodium chlorite as described herein. In some embodiments, the aqueous formulations described herein have a pH between about 7 and about 11, or between about 7.0 and about 10, or between about 7.0 and about 9.0, or between about 7.0 and about 8.5, or between about 7.1 and about 7.7, and have a concentration of chlorite between about 1 and about 100 mM. In some embodiments, the aqueous formulations described herein have a pH between about 7 and about 11, or between about 7.0 and about 10, or between about 7.0 and about 9.0, or between about 7.0 and about 8.5, or between about 7.1 and about 7.7, and have a concentration of chlorite between about 1 and about 5 mM. In some embodiments, the aqueous formulations described herein have a pH between about 7 and about 11, or between about 7.0 and about 10, or between about 7.0 and about 9.0, or between about 7.0 and about 8.5, or between about 7.1 and about 7.7, and have a concentration of chlorite between about 50 and about 80 mM.

In some embodiments, the formulations described herein are stable with respect to one or more of pH and chlorite ion degradation over a period of any of at least or greater than about 1 day, at least or greater than about 2 days, at least or greater than about 3 days, at least or greater than about 4 days, at least or greater than about 5 days, at least or greater than about 6 days, at least or greater than about 1 week, at least or greater than about 2 weeks, at least or greater than about 3 weeks, at least or greater than about 4 weeks, at least or greater than about 5 weeks, at least or greater than about 6 weeks, at least or greater than about 7 weeks, at least or greater than about 8 weeks, at least or greater than about 1 month, at least or greater than about 2 months, at least or greater than about 3 months, at least or greater than about 4 months, at least or greater than about 5 months, or at least or greater than about 6 months. In some embodiments, the formulations described herein are stable with respect to one or more of pH and chlorite ion degradation over a period of any of at least or greater than about 1 week. In some embodiments, the formulations are stable with respect to one or more of pH and chlorite ion degradation over a period of any of at least or greater than about 1 month. In some embodiments, the formulations described herein are stable with respect to one or more of pH or chlorite degradation at one or more of room temperature, refrigerated conditions, or approximately 4° C. In some embodiments, the formulations described herein are stable with respect to one or more of pH and chlorite ion degradation under conditions of diminished light or storage in a container that limits the amount of light to which the formulation is subjected. In some embodiments, the formulations described herein are stable with respect to one or more of pH and chlorite ion degradation when stored in the dark. Non-limiting examples of stable pH include changes by less than any of about 0.1, about 0.2, about 0.3, about 0.4, about 0.5, about 0.6, about 0.7, about 0.8, about 0.9, or about 1 relative to the pH of the formulation as initially prepared. In some embodiments, the pH of the formulation changes by less than about 0.2 relative to the pH of the formulation as initially prepared. The pH can be measured using, for example, a pH meter. Non-limiting examples of stable chlorite ion formulations include those in which less than about 0.1%, less than about 0.2%, less than about 0.3%, less than about 0.4%, less than about 0.5%, less than about 0.6%, less than about 0.7%, less than about 0.8%, less than about 0.9%, less than about 1%, less than about 2%, less than about 3%, less than about 4%, less than about 5%, less than about 6%, less than about 7%, less than about 8%, less than about 9%, or less than about 10% of the chlorite ion degrades into a non-chlorite ion relative to the amount of chlorite ion present in the formulation as initially prepared. In some embodiments, less than about 2% of the chlorite ion degrades into a non-chlorite ion relative to the amount of chlorite ion present in the formulation as initially prepared. In some embodiments, less than about 0.5% of the chlorite ion degrades into a non-chlorite ion relative to the amount of chlorite ion present in the formulation as initially prepared. The presence of non-chlorite ions can be measured, for example, using gas chromatography (GC) or mass spectrometry.

In some embodiments, the sodium chlorite formulations described herein comprise no greater than about 5% by mass of non-chlorite anions as contained in formulations not produced as described herein. In some embodiments, the chlorite formulations described herein comprise any of no greater than about 4%, no greater than about 3%, no greater than about 2%, no greater than about 1%, no greater than about 0.5%, no greater than about 0.3%, no greater than about 0.25%, no greater than about 0.2%, no greater than about 0.1%, no greater than about 0.05%, or no greater than about 0.02%, by mass of non-chlorite anions as contained in formulations not produced as described herein. In some embodiments, the sodium chlorite formulations described herein comprise no greater than about 4% by mass of non-chlorite anions as contained in other commercially available formulations not produced as described herein. In some embodiments, the sodium chlorite formulations described herein comprise no greater than about 2% by mass of non-chlorite anions as contained in formulations not produced as described herein. In some embodiments, the sodium chlorite formulations described herein comprise no greater than about 0.5% by mass of non-chlorite anions as contained in formulations not produced as described herein. In some embodiments, the sodium chlorite formulations described herein comprise no greater than about 0.05% by mass of non-chlorite anions as contained in formulations not produced as described herein. In some embodiments, the sodium chlorite formulations described herein are substantially free of non-chlorite anions. Non-limiting examples of methods of detection of non-chlorite anions include HPLC; SPCS, for example using a Novosep A2 column with 3.6 mM sodium carbonate as a mobile phase, 5μ, 250×4.0 mm, flow rate 0.8 mL/min; DS-Plus Suppressor, for example using a Novosep A2 column with 3.6 mM sodium carbonate as a mobile phase, 5μ, 250×4.0 mm, flow rate 0.8 mL/min; an Allsep A-2 Anion column using 2.1 mM NaHCO₃/1.6 mM Na₂CO₃ as a mobile phase, 100×4.6 mm, flow rate 2.0 mL/min; an anion HC column using 2.8 mM NaHCO₃/2.2 mM Na₂CO₃ in 10% methanol as a mobile phase, 150×4.6 mm, flow rate 1.4 mL/min; or an Allsep A-2 Anion column using 2.1 mM NaHCO₃/1.6 mM Na₂CO₃ as a mobile phase, 5μ, 100×4.6 mm, flow rate 1.0 mL/min.

In some embodiments, the sodium chlorite formulations described herein contain less than about 1.9% of chloride ions by mass on an all-ion basis. In some embodiments, the sodium chlorite formulation contains less than about 1.9%, less than about 1.8%; less than about 1.5%; less than about 1.0%; less than about 0.5%; less than about 0.3%; less than about 0.1%; less than about 0.05%; less than about 0.01%; less than about 0.001%; between about 0.001 and about 0.1%; between about 0.1 and about 0.5%; between about 0.5 and about 1.0%; between about 1.0 and about 1.5%; or between about 1.5 and about 1.8% of chloride ions by mass on an all-ion basis. In some embodiments, the sodium chlorite formulation contains less than about 0.5% by of chloride ions by mass on an all-ion basis. In some embodiments, the sodium chlorite formulation contains less than about 0.24% of chloride ions by mass on an all-ion basis. In some embodiments, the sodium chlorite formulation contains less than about 0.2% of chloride ions by mass on an all-ion basis. In some embodiments, the sodium chlorite formulation contains less than about 0.1% of chloride ions by mass on an all-ion basis. In some embodiments, the sodium chlorite formulation is substantially free of chloride ions. In some embodiments, the level of chloride ions is below the level of detection using, for example, HPLC, HLPC/MS, GC, or GC/MS.

In some embodiments, the sodium chlorite formulation contains less than about 1.5% of chlorate ions by mass on an all-ion basis. In some embodiments, the sodium chlorite formulation contains any of less than about 1.4%, less than about 1.3%; less than about 1.0%; less than about 0.5%; less than about 0.3%; less than about 0.1%; less than about 0.01%; less than about 0.001%; between about 0.001 and about 0.10%; between about 0.001 and about 0.010%; between about 0.01 and about 0.1%; between about 0.1 and about 0.5%; between about 0.5 and about 1.0%; or between about 1.0 and about 1.4% of chlorate ions by mass on an all-ion basis. In some embodiments, the sodium chlorite formulation is substantially free of chlorate ions. In some embodiments, the sodium chlorite formulation contains less than about 0.5% of chlorate ions by mass on an all-ion basis. In some embodiments, the sodium chlorite formulation is substantially free of chlorate ions. In some embodiments, the sodium chlorite formulation contains less than about 0.19% of chlorate ions by mass on an all-ion basis. In some embodiments, the sodium chlorite formulation contains less than about 0.1% of chlorate ions by mass on an all-ion basis. In some embodiments, the level of chlorate ions is below the level of detection using, for example, HPLC, HLPC/MS, GC, or GC/MS.

In some embodiments, the sodium chlorite formulation contains less than about 0.7% of sulfate ions by mass on an all-ion basis. In some embodiments, the sodium chlorite formulation contains less than about 0.65%; less than about 0.6%; less than about 0.5%; less than about 0.4%; less than about 0.3%; less than about 0.2%; less than about 0.1%; less than about 0.08%; less than about 0.07%; less than about 0.06%; less than about 0.05%; less than about 0.005%; less than about 0.0005%; between about 0.001 and about 0.1%; between about 0.01 and about 0.1%; between about 0.01 and about 0.5%; between about 0.06 and about 0.08%; or between about 0.5 and about 0.65% of sulfate ions by mass on an all-ion basis. In some embodiments, the sodium chlorite formulation contains between about 0.5 and about 0.65% of sulfate ions by mass on an all-ion basis. In some embodiments, the sodium chlorite formulation contains less than about 0.5% by weight of sulfate ions by mass on an all-ion basis. In some embodiments, the sodium chlorite formulation contains less than about 0.08% by weight of sulfate ions. In some embodiments, the sodium chlorite formulation is substantially free of sulfate ions. In some embodiments, the level of sulfate ions is below the level of detection using, for example, HPLC, HLPC/MS, GC, or GC/MS.

In some embodiments, the sodium chlorite formulations described herein comprise phosphate ions. In some embodiments, a sodium chlorite formulation comprises chlorite ions, an aqueous solvent, sodium ions, and phosphate ions. In some embodiments, the aqueous solvent consists essentially of water. In some embodiments, a sodium chlorite formulation consists essentially of chlorite ions, water, sodium ions, and phosphate ions, and is substantially free of chlorate ion. In some embodiments, a sodium chlorite formulation consists essentially of chlorite ions, water, sodium ions, and phosphate ions, a pharmaceutically acceptable diluent, and is substantially free of chlorate ion. In some embodiments, phosphate ions are provided in whole or in part as monosodium phosphate or disodium phosphate. In some embodiments, the pharmaceutically acceptable diluent is a saline solution, for example, physiological saline.

In some embodiments, the sodium chlorite formulations described herein comprise no greater than about 10% by mass of by products or impurities present in commercially-available, technical grade sodium chlorite. Non-limiting examples of by-products or impurities present in commercially-available, technical grade sodium chlorite include chlorate ions, sulfate ions, chlorine dioxide, chloride ions, sodium bicarbonate, and sodium carbonate. In some embodiments, the sodium chlorite formulations described herein comprise no greater than about 15%, no greater than about 12%, no greater than about 10%, no greater than about 9%, no greater than about 8%, no greater than about 7%, no greater than about 6%, no greater than about 5%, no greater than about 4%, no greater than about 3%, no greater than about 2%, no greater than about 1%, no greater than about 0.5%, no greater than about 0.3%, no greater than about 0.1%, between about 0.1 and about 5%; between about 5 and about 10%; or between about 10 and about 15% by mass of one or more degradation products or impurities present in commercially-available, technical grade sodium chlorite, including but not limited to one or more of chlorate ion and sulfate ion. In some embodiments, the sodium chlorite formulations described herein comprise no greater than about 0.5% by mass of degradation products or impurities present in commercially-available, technical grade sodium chlorite, including but not limited to one or more of chlorate ion and sulfate ion. In some embodiments, the sodium chlorite formulations described herein comprise no greater than about 5% by mass of degradation products or impurities present in commercially-available, technical grade sodium chlorite, including but not limited to one or more of chlorate ion and sulfate ion. In some embodiments, the sodium chlorite formulations described herein are substantially free of the degradation products or impurities present in commercially-available, technical grade sodium chlorite, including but not limited to chlorate ion and sulfate ion.

In some embodiments, the formulations described herein are less toxic to a subject than is a sodium chlorite formulation prepared by a method or than as described herein at the same concentration of sodium chlorite, when administered, for example, by one of the routes of administration described herein, for example, non-topical, systemic, parenteral, or intravenous administration. In some embodiments, the toxicity of a sodium chlorite formulation is analyzed for toxicity using an in vivo or in vitro toxicity assay. In some embodiments, the sodium chlorite formulation is analyzed for toxicity using a non-specific in vitro toxicity assay.

In some embodiments, toxicity is measured according to various response indicia of toxicity in a subject after administration of the sodium chlorite formulations described herein, as compared to administration of a sodium chlorite formulation not prepared as described herein. In some embodiments, toxicity is measured relative to systemic administration of chlorite formulated as WF10. In some embodiments, toxicity is measured relative to intravenous administration of sodium chlorite formulated as WF10 to a subject. In some embodiments, toxicity is measured after administration to a mammalian subject, including but not limited to a human subject. In some embodiments, toxicity is measured as one or more of irritation to the body surface to which the sodium chlorite formulation is exposed. Non-limiting examples of toxicity include nausea, vomiting, diarrhea, abdominal pain, hemolysis, methemoglobinemia, cyanosis, anuria, coma, convulsions, liver damage, kidney damage, loss of appetite, and weight loss. In some embodiments, toxicity is measured as one or more of asthenia, injection site pain, headache, rhinitis, and diarrhea. In some embodiments, toxicity is measured as anemia. In some embodiments, toxicity is measured as asthenia. In some embodiments, toxicity is measured as injection site reaction. In some embodiments, toxicity is measured as injection site pain.

### Methods of Adjusting the pH of Formulations Sensitive to pH

Various methods can be used to adjust the pH of formulations and pharmaceutical formulations comprising sodium chlorite. Non-limiting examples of pH adjusting agents include weak acids and weak bases having a pKa of about 4 to about 9, a pKa of about 5 to about 9, or a pKa of about 5 to about 8, or a pKa of about 6 to about 7.5. Non-limiting examples include a phosphate buffer having a pKa of about 4 to about 9, for example, monobasic phosphate, or monosodium phosphate and/or disodium phosphate and lower alkanoic acids, for example, acetic acid or propionic acid.

Some pH adjusting agents expose a formulation to high local acidity in the local volume of the pH adjusting agent. In the presence of high local acidity, some amount of non-chlorite compounds can form, for example, chlorate ion and/or chlorine dioxide. In some embodiments, formation of such compounds is avoided because such compounds are not necessarily inactive in a physiological system. In some embodiments, the pH of a formulation is adjusted to between about 7 and about 11.5, between about 7 and about 11, between about 7 and about 10, between about 7 and about 9.5, between about 7 and about 9.0, between about 7 and about 8.5, or between about 7.1 and about 7.7 using a pH adjusting agent that does not expose the formulation to high local acidity in the local volume around the pH adjusting agent.

In some embodiments, the pH of a sodium chlorite formulation is adjusted to a pH level described herein. In some embodiments, the pH of a sodium chlorite formulation is between about 7 and about 11.5. In some embodiments, the method comprises adjusting the pH of a formulation comprising sodium chlorite to between about 7 and about 11; between about 7 and about 10.5; between about 7 and about 10; between about 7 and about 9.5; between about 7 and about 9; between about 7 and about 8.5; between about 7 and about 8; between about 7 and about 7.5; between about 7.5 and about 8; between about 7.5 and about 8.5; between about 7.1 and about 7.7; between about 7.2 and about 7.6; between about 7.3 and about 7.5; between about 8 and about 9; between about 8 and about 8.5; between about 8.5 and about 9; about 7.0; about 7.1; about 7.2; about 7.3; about 7.4; about 7.5; about 7.6; about 7.7; about 7.8; about 7.9; about 8.0; about 8.1; about 8.2; about 8.3; about 8.4; about 8.5; about 8.6; about 8.7; about 8.8; or about 8.9 using a pH adjusting agent that does not expose the sodium chlorite to a high local acidity. In some embodiments, the method comprises adjusting the pH of a formulation to between about 7 and about 8.5. In some embodiments, the method comprises adjusting the pH of a formulation to between about 7 and about 8. In some embodiments, the method comprises adjusting the pH of a formulation comprising chlorite to between about 7.1 and about 7.7. In some embodiments, the method comprises adjusting the pH of a formulation to about 7.4.

In a non-limiting example, the pH of a mixture is adjusted using a pH adjusting agent that does not subject the sodium chlorite to a local pH of below 7 when exposed to the mixture. In some embodiments, the pH adjusting agent is monosodium phosphate, disodium phosphate, or a mixture thereof. In some embodiments, monosodium phosphate and/or disodium phosphate is added to the mixture as a solid or in solution. In some embodiments, the pH adjusting agent is acetic acid.

In some embodiments, the pH of sodium chlorite is adjusted by adding the sodium chlorite or an aqueous mixture thereof to a solution containing buffer. In some embodiments, the pH of sodium chlorite is adjusted by adding the sodium chlorite or an aqueous mixture thereof to a solution of a phosphate buffer.

In some embodiments, one or more pH-adjusting agents are used to adjust the pH of a sodium chlorite solution or mixture, and the resulting solution or mixture is analyzed for the presence of degradation products of chlorite ion, including but not limited to degradation products generated by high local acidity. In some embodiments, pH-adjusting agents such as acetic acid, monosodium phosphate, and/or disodium phosphate are used to adjust the pH of a chlorite solution or mixture, and the resulting solution or mixture is analyzed for the presence of chlorate ion or chlorine dioxide.

In some embodiments, the resulting solution or mixture is analyzed for degradation products using analytical methods such as HPLC and/or mass spectrometry. In some embodiments, the resulting solution or mixture is analyzed for degradation products using a toxicity assay. In some embodiments, the resulting solution or mixture is analyzed for impurities using a non-specific toxicity assay.

In some embodiments, the pH of a chlorite formulation is adjusted after a purification step. In some embodiments, the pH of a formulation is adjusted to between about 7 and about 11.5 without the generation of chlorite degradation products that are a result of high local acidity. In some embodiments, the pH of a formulation is adjusted to between about 7 and about 8.0 without the generation of chlorite degradation products that are a result of high local acidity. In some embodiments, the pH of the formulation is adjusted to any of between about 7 and about 11; between about 7 and about 10.5; between about 7 and about 10; between about 7 and about 9.5; between about 7 and about 9; between about 7 and about 8.5; between about 7 and about 8; between about 7 and about 7.5; between about 7.5 and about 8; between about 7.5 and about 8.5; between about 8 and about 9; between about 8 and about 8.5; or between about 8.5 and about 9 without the generation of chlorite degradation products that are a result of high local acidity.

### Pharmaceutical Formulations

In some embodiments, the pharmaceutical composition can comprise a pharmaceutically-acceptable excipient.

Non-limiting examples of pharmaceutically-acceptable excipients include: carriers, adjuvants, diluents, stabilizers, wetting agents, emulsifiers, buffers, preservatives, flavorings, inactive ingredients, gel formulations, erodible and non-erodible polymers, microspheres, liposomes, solvents, coatings, antibacterial and antifungal agents, isotonic and absorption delaying agent, or any combinations thereof. In some embodiments, the percent of the pharmaceutically-acceptable excipient per the total mass or volume of the formulation or pharmaceutical formulation is no greater than about 10%, no greater than about 9%, no greater than about 8%, no greater than about 7%, no greater than about 6%, no greater than about 5%, no greater than about 4%, no greater than about 3%, no greater than about 2%, no greater than about 1%, no greater than about 0.5%, no greater than about 0.4%, no greater than about 0.3%, no greater than about 0.2%, no greater than about 0.1%, or no greater than about 0.05%.

The chlorite formulations described herein can comprise one or more pharmaceutically-acceptable excipients that do not generate, or do not substantially generate, a non-chlorite compound.

The chlorite formulation can comprise a stabilizer. Stabilizers can, for example: (1) improve the compatibility of excipients with a container, including a glass bottle or an encapsulating material such as gelatin; (2) improve the stability of chlorite ion (e.g., prevent degradation); or (3) improve formulation stability, or combinations thereof. Non-limiting examples of stabilizers include: fatty acids, fatty alcohols, alcohols, long chain fatty acid esters, long chain ethers, hydrophilic derivatives of fatty acids, polyvinyl pyrrolidones, polyvinyl ethers, polyvinyl alcohols, hydrocarbons, hydrophobic polymers, moisture-absorbing polymers, and combinations thereof. Amide analogues of stabilizers can also be used. The chosen stabilizer can change the hydrophobicity of the formulation (e.g., oleic acid, waxes), or improve the mixing of various components in the formulation (e.g., ethanol), control the moisture level in the formula (e.g., PVP or polyvinyl pyrrolidone), control the mobility of the phase (substances with melting points higher than room temperature such as long chain fatty acids, alcohols, esters, ethers, amides etc. or mixtures thereof; waxes), and/or improve the compatibility of the formula with other materials (e.g., oleic acid or wax). Some of these stabilizers can be used as solvents/co-solvents (e.g., ethanol). Stabilizers can be present in sufficient amount to inhibit chlorite ion degradation.

Additives and diluents can optionally be added to the pharmaceutical composition. Non-limiting examples include thickening, granulating, dispersing, flavoring, sweetening, coloring, and stabilizing agents, including pH stabilizers, other excipients, anti-oxidants (e.g., tocopherol, BHA, BHT, TBHQ, tocopherol acetate, ascorbyl palmitate, and ascorbic acid propyl gallate), and preservatives (e.g., parabens). Non-limiting examples of preservatives include benzylalcohol, ethylalcohol, benzalkonium chloride, phenol, and chlorobutanol. Some antioxidants provide oxygen or peroxide inhibiting agents and can be used in the formulations described herein. Non-limiting examples include butylated hydroxytoluene, butylhydroxyanisole, propyl gallate, ascorbic acid palmitate, and a-tocopherol. Non-limiting examples of thickening agents include lecithin, hydroxypropylcellulose, and aluminum stearate.

In some embodiments, the sodium chlorite formulations of the disclosure are sterile. Sterilization can be by any method that is compatible with sodium chlorite. In some embodiments, sterilization is via a method that does not generate a substantial amount of a degradation product of chlorite ion. In some embodiments, sterilization is via a method that does not cause a structural change in chlorite ion. In some embodiments, the formulations described herein are sterile pharmaceutical formulations for parenteral or intravenous administration. In some embodiments, the chlorite formulations described herein are sterile filtered, for example, through a sterile 0.22 micron filter.

A sodium chlorite-containing agent in any form disclosed herein can be provided in any suitable formulation, which can be selected according to the desired route of administration as disclosed herein. In some embodiments, the formulation comprises purified sodium chlorite including water content, buffer such as sodium phosphate dibasic, and sterile water for injection (USP) as a vehicle. In some embodiments, the amount of purified sodium chlorite is about 5.6 mg/mL (including a batch factor to reflect the water content of the batch), the amount of sodium phosphate dibasic is about 0.107 mg/mL, and sterile water to bring the volume up to 1 mL. In some embodiments, a formulation according to the disclosure consists essentially of purified sodium chlorite, buffer, and sterile water for injection (USP) as the vehicle. In some embodiments, the formulation is stable for up to 3 months at 25° C./60% relative humidity and/or 40° C./75% relative humidity conditions.

### EXAMPLES

### Example 1. Brine Safety Solution Preparation

Brine safety solution in Hedpak was prepared by the following steps: 1) charging 1.8±0.5 kg sodium chloride to an IMP Hedpak; 2) charging 16.2±0.5 kg Pharma Water to the HedPak; and 3) agitating the mixture to dissolve solids. The Hedpak was labeled as 10% Brine Safety Solution.

Brine safety solution in a HDPE Drum was prepared by the following steps: 1) charging 4.0±0.5 kg sodium chloride to a HDPE Drum; 2) charging 36.0±0.5 kg Pharma Water to the HDPE Drum; and 3) agitating the mixture to dissolve solids. The HDPE Drum was labeled as 10% Brine Safety Solution.

About 20 L of 10% sodium hydroxide (Caustic Soda) was prepared in Scrubber system B1202 and X1201.

### Example 2. Dissolution and Filtration

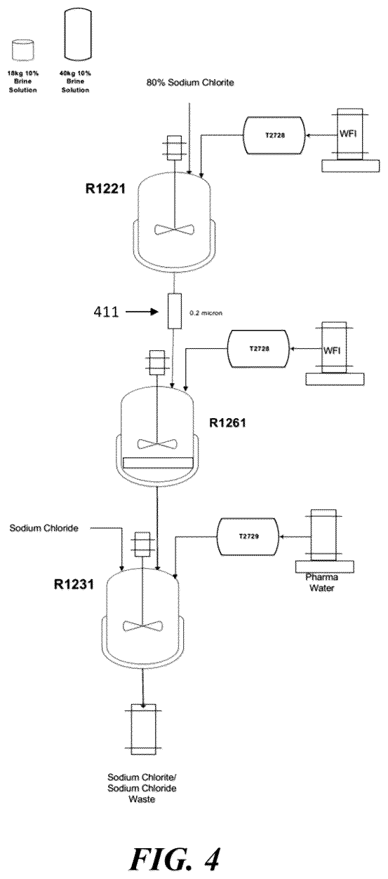

As illustrated in FIG. 4, 10.4±0.5 kg water for injection (WFI) was massed to a container T2728 and charged to reactor R1221 using low pressure nitrogen gas (LPN). 20.0±0.2 kg of 80% sodium chlorite was charged to the reactor R1221. Another 5.4±0.5 kg WFI massed to the container T2728 was charged to the reactor R1221 using LPN to rinse down any solids on the reactor walls. The reactor was subsequently purged with nitrogen and sealed.

The mixture of sodium chlorite and WFI in the reactor R1221 was agitated and heated to 70±5° C. at a heating rate of 0.5° C./min. After the temperature reached 70±5° C., the reactor was agitated for 30 to 90 minutes (e.g., 60 minutes) at 70±5° C. to ensure the complete dissolution of sodium chlorite in WFI. Subsequently, the 70±5° C. solution was filtered/transferred through a 0.2-micron cartridge filter to a reactor R1261. The filtration/transfer was performed as quickly as possible to avoid cooling and yield loss during the process. Nitrogen was blown on cartridge filter until filtration/transfer was complete.

The reactor R1221 was then washed with WFI and dried. After the filtration/transfer was complete, the reactor R1221 was cooled to 20±5° C. and 40±1 kg WFI was added to the reactor R1221 under locked vacuum. The reactor R1221 was heated to reflux for a minimum of 60 minutes. The reactor R1221 was then cooled to 20±5° C. and the substances in the reactor were discharged to a HDPE waste drum. The reactor was heated to 60° C. and purged with nitrogen until dry. The reactor was examined for cleanness (e.g., visually). The washing and drying process can be repeated until the reactor is clean and dry. The reactor was then cooled to 20±10° C.

### Example 3. Recrystallization

Recrystallization step I. As illustrated in FIG. 4, the reactor R1261 was heated to about 70° C. and was allowed to receive the solution from the reactor R1221 through the cartridge filter. The solution was heated and agitated at 70±5° C. for 5-10 minutes. The solution was then slowly cooled to 20±5° C. over a period of about 90 minutes. Agitation was ceased once the solution reached 20° C. The reactor R1261 was subsequently cooled to −20±5° C. over a period of at least 360 min and held for 4 to 24 hours until the mixture froze. The reactor R1261 was heated to 10±5° C. without agitation. Liquid was drained from the reactor R1261 to the jacket R1231 while the reactor R1231 was under vacuum and the reactor R1261 was under LPN, until the filtrates (liquid phase of the mixture) stopped coming off the reactor R1261.

Recrystallization step II. 5.0±0.5 kg WFI was massed to T2728 and charged to the reactor R1261 using LPN. The mixture of sodium chlorite and WFI in the reactor R1261 was agitated and mixed for 2 to 3 hours at 35±10° C. A first sample was collected from the reactor R1261 for testing (IPC 1).

The reactor R1261 was cooled to about 15° C. over a period of at least 30 min and held at 15±5° C. for about 1 hour. The reactor R1261 was then cooled to about −20° C. over a period of at least 260 min and held at −20±5° C. for 4 to 24 hours. The reactor R1261 was then heated to about 15° C. over a period of at least 90 min. Once the mixture was no longer frozen, the mixture was maintained at 10±5° C. Liquid was drained from the reactor R1261 to the reactor R1231 while the jacket R1231 was under vacuum and the reactor R1261 was under LPN, until the filtrates (liquid phase of the mixture) stopped coming off the reactor R1261.

Recrystallization step III. 3.0±0.5 kg WFI was massed to T2728 and charged to the reactor R1261 using LPN. The mixture of sodium chlorite and WFI in the reactor R1261 was agitated and mixed for 2 to 3 hours at 25±10° C. A second sample was collected from the reactor R1261 for testing (IPC 2).

The reactor R1261 was then cooled down to about −20° C. over a period of at least 360 min and held at −20±5° C. for 4 to 24 hours. Next, the reactor R1261 was heated back to about 15° C. over a period of at least 90 min. Once the mixture was no longer frozen, the mixture was brought to 5-10° C., followed by agitation at 100 rpm for at least 1 hour. Thereafter, the agitation was ceased and liquid was drained from the reactor R1261 to the jacket R1231 while the reactor R1231 was under vacuum and the reactor R1261 was under LPN, until the filtrates (liquid phase of the mixture) stopped coming off the reactor R1261.

Recrystallization step IV. 3.0±0.5 kg WFI was massed to T2728 and charged to the reactor R1261 using LPN. The mixture of sodium chlorite and WFI in the reactor R1261 was agitated and mixed for 2 to 3 hours at 25±10° C. A third sample was collected from the reactor R1261 for testing (IPC 3).

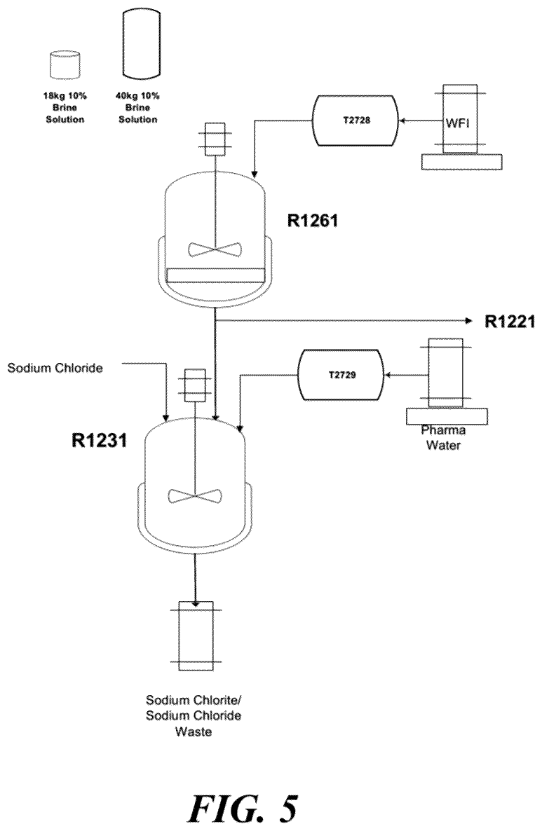

Transfer of content: Once the IPC met the desired characteristics and the liquid was completely drained to the reactor R1231, 3.0±0.5 kg WFI was massed to T2728 and charged to the reactor R1261 using LPN. The mixture in the reactor R1261 was agitated at 25±5° C. for a minimum of 30 minutes until all solids were dissolved. The content in the reactor R1261 was transferred to a reactor R1221 via flex hose from the drain valve on the reactor R1261 to inlet XV-R1221-P083 of the reactor R1221 (see FIG. 5). After the transfer was completed, the drain valve on the reactor R1261 was closed.

1.0±0.5 kg WFI was massed to T2728 and charged to the reactor R1261 via charging port to rinse the walls of the reactor R1261. Following the rinse, the content in the reactor R1261 was transferred to the reactor R1221 via flex hose from the drain valve on the reactor R1261 to inlet XV-R1221-P083 of the reactor R1221.

Filtrate collection and treatment: The jacket R1231 was pre-treated as follows before receiving the filtrate from the reactor R1261:1) 2±1 kg sodium chloride was added to the jacket R1231; 2) 25±1 kg Pharma Water was massed to the container T2729 and charged to the jacket R1231 using LPN; 3) the jacket R1231 was purged with nitrogen; and 4) the mixture was agitated at 10±5° C. After receiving the filtrate from the reactor R1261, the content in the jacket R1231 was discharged to a HDPE drum for offsite disposal.

### Example 4. Packaging

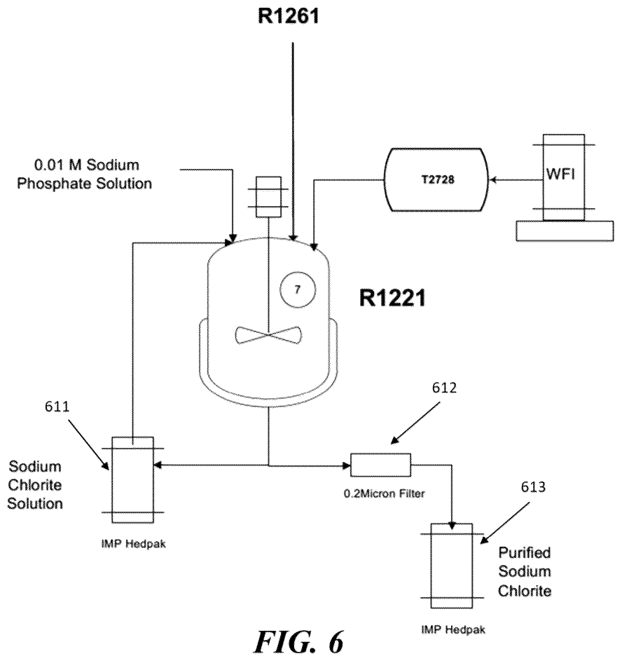

FIG. 6 shows an example of a transfer and packaging process. The content (sodium chlorite solution) in the reactor R1221 collected from the reactor R1261 was agitated for 30 min and discharged to a tared IMP HedPak 611. The mass of the sodium chlorite solution was recorded. 5 samples (i.e., IPC 1-5) from the IMP Hedpak 611 were submitted to QC lab for evaluation before pH adjustment and dilution.

1 L aliquot of the sodium chlorite solution was transferred from the IMP Hedpak 611 to the reactor R1221 and 0.1 M (mol/L) sodium phosphate solution was added to the reactor R1221 to adjust the pH of the sodium chlorite solution to a target of 7.5 to 7.9 (e.g., 7.6). 6 samples (i.e., IPC 1-6) were submitted for pH measurement.

WFI was massed to the container T2728 and charged to the reactor R1221 using vacuum to achieve a target concentration of 115 mg/mL of sodium chlorite. The solution in the reactor R1221 was subsequently agitated at 25±5° C. for a minimum of 15 minutes. The solution was then discharged to a tared IMP Hedpak 613 via 0.2-micron cartridge filter 612 for storage at 2-8° C.

### Embodiments

Embodiment A1. A composition comprising solid sodium chlorite in a single portion of at least one kilogram, wherein the solid sodium chlorite has a purity of at least 96%.

Embodiment A2. The composition of embodiment A1, wherein the solid sodium chlorite has a purity of at least 98%.

Embodiment A3. The composition of embodiment A1, wherein the solid sodium chlorite has a purity of at least 99%.

Embodiment A4. The composition of any one of embodiments A1-A3, wherein the single portion is at least 10 kg.

Embodiment A5. The composition of any one of embodiments A1-A3, wherein the single portion is at least 100 kg.

Embodiment A6. The composition of any one of embodiments A1-A3, wherein the single portion is at least 1,000 kg.

Embodiment A7. The composition of any one of embodiments A1-A6, wherein the composition further comprises sodium chloride.

Embodiment A8. The composition of any one of embodiments A1-A7, wherein the composition further comprises sodium chlorate.

Embodiment A9. The composition of any one of embodiments A1-A8, wherein the composition is in a pharmaceutically-acceptable container.

Embodiment B1. An article of manufacture comprising:
a) an inner packaging material, wherein the inner packaging material is substantially free of acid, metal, and organic chemicals, wherein the inner packaging material is substantially airtight;
b) an outer packaging material, wherein the outer packaging material is substantially opaque; and
c) a sample of solid sodium chlorite in an amount of at least one kilogram and purity of at least 96%,
   wherein the solid sodium chlorite is packaged in the inner packaging material such that the solid sodium chlorite is not exposed to acid, metal, and organic chemicals; and wherein the inner packaging material is packaged within the outer packaging material such that the solid sodium chlorite is not exposed to ambient light.

Embodiment B2. The article of manufacture of embodiment B1, wherein the solid sodium chlorite has a purity of at least 98%.

Embodiment B3. The article of manufacture of embodiment B1, wherein the solid sodium chlorite has a purity of at least 99%.

Embodiment B4. The article of manufacture of any one of embodiments B1-B3, wherein the amount is at least 10 kg.

Embodiment B5. The article of manufacture of any one of embodiments B1-B3, wherein the amount is at least 100 kg.

Embodiment B6. The article of manufacture of any one of embodiments B1-B3, wherein the amount is at least 1,000 kg.

Embodiment B7. The article of manufacture of any one of embodiments B1-B6, wherein the sample of solid sodium chlorite further comprises sodium chloride.

Embodiment B8. The article of manufacture of any one of embodiments B1-B7, wherein the sample of solid sodium chlorite further comprises sodium chlorate.

Embodiment B9. The article of manufacture of any one of embodiments B1-B8, wherein the sample of solid sodium chlorite is in a pharmaceutically-acceptable container.

Embodiment B10. The article of manufacture of any one of embodiments B1-B9, wherein the inner packaging material is glass or HDPE.

Embodiment B11. The article of manufacture any one of embodiments B1-B10, wherein the outer packaging material is HDPE.

Embodiment C1. A composition comprising:
a) a solute in an amount of at least one kilogram, wherein at least 96% of the solute by mass is sodium ions and chlorite ions; and
b) water, wherein the solute is dissolved in the water at a level of about 100 mg/mL to about 125 ng/mL.

Embodiment C2. The composition of embodiment C1, wherein at least 98% of the solute by mass is sodium ions and chlorite ions.

Embodiment C3. The composition of embodiment C1, wherein at least 99% of the solute by mass is sodium ions and chlorite ions.

Embodiment C4. The composition of any one of embodiments C1-C3, wherein the amount is at least 10 kg.

Embodiment C5. The composition of any one of embodiments C1-C3, wherein the amount is at least 100 kg.

Embodiment C6. The composition of any one of embodiments C1-C3, wherein the amount is at least 1,000 kg.

Embodiment C7. The composition of any one of embodiments C1-C6, wherein the solute further comprises sodium chloride.

Embodiment C8. The composition OF any one of embodiments C1-C7, wherein the solute further comprises sodium chlorate.

Embodiment C9. The composition of any one of embodiments C1-C8, wherein the composition is in a pharmaceutically-acceptable container.

Embodiment D1. A composition comprising:
a) a solute in an amount of at least one kilogram, wherein at least 96% of the solute by mass is sodium ions and chlorite ions; and
b) phosphate buffer, wherein the solute is dissolved in the phosphate buffer.

Embodiment D2. The composition of embodiment D1, wherein at least 98% of the solute by mass is sodium ions and chlorite ions.

Embodiment D3. The composition of embodiment D1, wherein at least 99% of the solute by mass is sodium ions and chlorite ions.

Embodiment D4. The composition of any one of embodiments D1-D3, wherein the amount is at least 10 kg.

Embodiment D5. The composition of any one of embodiments D1-D3, wherein the amount is at least 100 kg.

Embodiment D6. The composition of any one of embodiments D1-D3, wherein the amount is at least 1,000 kg.

Embodiment D7. The composition of any one of embodiments D1-D6, wherein the solute further comprises sodium chloride.

Embodiment D8. The composition of any one of embodiments D1-D7, wherein the solute further comprises sodium chlorate.

Embodiment D9. The composition of any one of embodiments D1-D8, wherein the composition is in a pharmaceutically-acceptable container.

Embodiment D10. The composition of any one of embodiments D1-D9, wherein the phosphate buffer has a pH of about 7 to about 11.

Embodiment D11. The composition of any one of embodiments D1-D9, wherein the phosphate buffer has a pH of about 7 to about 9.5.

Embodiment D12. The composition of any one of embodiments D1-D9, wherein the phosphate buffer has a pH of about 7.5 to about 9.

Embodiment E1. An article of manufacture comprising a plurality of unit dosage forms, wherein each unit dosage form independently comprises:
a) a solute, wherein at least 96% of the solute by mass is sodium ions and chlorite ions; and
b) phosphate buffer, wherein the solute is dissolved in the phosphate buffer,
   wherein each unit dosage form independently has a pH of about 7 to about 11,
   wherein each unit dosage form is independently packaged in pharmaceutically-acceptable packaging, each providing a packaged dose;
   wherein the packaged doses are contained in a pharmaceutically-acceptable container; and
   wherein the amounts of the sodium ions and the chlorite ions in the unit dosage forms in the pharmaceutically-acceptable container sun to a total of at least 1 kilogram

Embodiment E2. The article of manufacture of embodiment E1, wherein at least 98% of the solute by mass is sodium ions and chlorite ions.

Embodiment E3. The article of manufacture of embodiment E1, wherein at least 99% of the solute by mass is sodium ions and chlorite ions.

Embodiment E4. The article of manufacture of any one of embodiments E1-E3, wherein the total is at least 10 kg.

Embodiment E5. The article of manufacture of any one of embodiments E1-E3, wherein the total is at least 100 kg.

Embodiment E6. The article of manufacture of any one of embodiments E1-E3, wherein the total is at least 1,000 kg.

Embodiment E7. The article of manufacture of any one of embodiments E1-E6, wherein the solute further comprises sodium chloride.

Embodiment E8. The article of manufacture of any one of embodiments E1-E7, wherein the solute further comprises sodium chlorate.

Embodiment E9. The article of manufacture of any one of embodiments E1-E8, wherein each unit dosage form independently has a pH of about 7 to about 9.5.

Embodiment E10. The article of manufacture of any one of embodiments E1-E8, wherein each unit dosage form independently has a pH of about 7.5 to about 9.

Embodiment FT. An apparatus comprising:
a) a glass chamber, wherein:
   1) the glass chamber is double-walled;
   2) the glass chamber is airtight;
   3) the glass chamber is substantially free of air;
   4) the glass chamber is substantially free of metal;
   5) the glass chamber is substantially free of acid;
   6) the glass chamber is substantially free of organic chemicals;
   7) the glass chamber comprises a bottom; and
   8) the glass chamber has a volume of at least one liter;
b) an access port attached to the glass chamber, wherein:
   1) the access port is configured to allow insertion of a sample tool into the glass chamber from outside the glass chamber when the access port is open; and
   2) the access port forms an air-tight seal when the access port is closed;
c) a filter inside the glass chamber at the bottom of the glass chamber, wherein:
   1) the filter is corrosion resistant; and
   2) the filter is resistant to chemical reactivity with sodium chlorite; and
d) a temperature-regulating element, wherein the temperature-regulating element is in contact with the glass chamber such that the temperature-regulating element is disposed to regulate temperature within the glass chamber.

Embodiment F2. The apparatus of embodiment F1, wherein the volume of the glass chamber is at least ten liters.

Embodiment F3. The apparatus of embodiment F1, wherein the volume of the glass chamber is at least one hundred liters.

Embodiment F4. The apparatus of any one of embodiments F1-F3, wherein the glass chamber is borosilicate glass.

Embodiment F5. The apparatus of any one of embodiments F1-F4, wherein the glass chamber is type 1 class A borosilicate glass.

Embodiment F6. The apparatus of any one of embodiments F1-F5, wherein the filter is plastic.

Embodiment F7. The apparatus of any one of embodiments F1-F6, wherein the filter is polytetrafluoroethylene.

Embodiment G1. A method comprising:
a) contacting crude sodium chlorite with a liquid, thereby generating a sodium chlorite mixture; and
b) obtaining purified sodium chlorite from the sodium chlorite mixture, wherein the purified sodium chlorite has a purity of at least 96%.

Embodiment G2. The method of embodiment G1, wherein the crude sodium chlorite is up to about 80% pure.

Embodiment G3. The method of any one of embodiments G1-G2, wherein the liquid comprises water.

Embodiment G4. The method of any one of embodiments G1-G2, wherein the liquid comprises pharma water.

Embodiment G5. The method of any one of embodiments G1-G2, wherein the liquid comprises water for injection.

Embodiment G6. The method of any one of embodiments G1-G5, wherein the contacting is performed at a temperature from about 50° C. to 100° C.

Embodiment G7. The method of any one of embodiments G1-G5, wherein the contacting is performed at a temperature of about 70° C.

Embodiment G8. The method of any one of embodiments G1-G5, wherein the contacting is performed with agitation of the sodium chlorite mixture.

Embodiment G9. The method of any one of embodiments G1-G8, further comprising, subsequent to a) and prior to b), passing the sodium chlorite mixture through a filter.

Embodiment G10. The method of any one of embodiments G1-G8, further comprising, subsequent to a) and prior to b), passing the sodium chlorite mixture through a 0.2 micro cartridge filter.

Embodiment G11. The method of any one of embodiments G1-G10, wherein b) is performed in a chamber, wherein the chamber is airtight and is substantially free of air, metal, acid, and organic chemicals.

Embodiment G12. The method of any one of embodiments G1-G11, wherein the contacting the crude sodium chlorite with the liquid comprises substantially dissolving the crude sodium chlorite in the liquid.

Embodiment G13. The method of any one of embodiments G1-G12, wherein the obtaining the purified sodium chlorite from the sodium chlorite mixture comprises separating a solid phase of the sodium chlorite mixture from a liquid phase of the sodium chlorite mixture.

Embodiment G14. The method of any one of embodiments G1-G13, wherein the obtaining the purified sodium chlorite from the sodium chlorite mixture comprises separating a solid phase of the sodium chlorite mixture from a liquid phase of the sodium chlorite mixture, wherein the solid phase of the sodium chlorite mixture comprises crystalline sodium chlorite.

Embodiment G15. The method of any one of embodiments G1-G14, wherein the obtaining the purified sodium chlorite from the sodium chlorite mixture comprises crystallizing the purified sodium chlorite from the sodium chlorite mixture.

Embodiment G16. The method of any one of embodiments G1-G15, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture.

Embodiment G17. The method of any one of embodiments G1-G16, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture.

Embodiment G18. The method of any one of embodiments G1-G17, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C.

Embodiment G19. The method of any one of embodiments G1-G18, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to about 10° C.

Embodiment G20. The method of any one of embodiments G1-G19, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture.

Embodiment G21. The method of any one of embodiments G1-G20, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; further comprising separating the solid phase from the liquid phase.

Embodiment G22. The method of any one of embodiments G1-G21, wherein the obtaining the purified sodium chlorite from the sodium chlorite mixture comprises crystallizing the purified sodium chlorite from the sodium chlorite mixture, wherein the crystallizing the purified sodium chlorite from the sodium chlorite mixture comprises freezing the sodium chlorite mixture to provide a frozen sodium chlorite mixture, then heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; further comprising separating the solid phase from the liquid phase by filtration.

Embodiment G23. The method of any one of embodiments G21-G22, wherein the solid phase comprises crystalline sodium chlorite.

Embodiment G24. The method of embodiment any one of embodiments G1-G23, further comprising measuring a purity of the purified sodium chlorite.

Embodiment G25. The method of any one of embodiments G1-G24, further comprising measuring a purity of the purified sodium chlorite, and: i) if the purity meets a threshold purity value, collecting the sodium chlorite; or ii) if the purity does not meet the threshold purity value, dissolving the purified sodium chlorite in a solvent and recrystallizing the purified sodium chlorite from the solvent, wherein the threshold purity value is at least 96% pure.

Embodiment G26. The method of any one of embodiments G1-G25, further comprising transferring the purified sodium chlorite to a container.

Embodiment G27. The method of any one of embodiments G1-G26, further comprising dissolving the purified sodium chlorite in water.

Embodiment G28. The method of any one of embodiments G1-G27, further comprising dissolving the purified sodium chlorite in water to provide dissolved sodium chlorite, wherein the dissolved sodium chlorite is in water at a level of about 100 mg/mL to about 125 mg/mL.

Embodiment G29. The method of any one of embodiments G1-G28, further comprising processing the purified sodium chlorite into a plurality of unit dosage forms, wherein each unit dosage form independently comprises purified sodium chlorite dissolved in phosphate buffer at a pH of about 7 to about 11.

Embodiment G30. The method of embodiment G29, further comprising packaging the plurality of unit dosage forms into pharmaceutically-acceptable packaging.

Embodiment G31. The method of any one of embodiments G1-G30, wherein the contacting the crude sodium chlorite with the liquid comprises contacting at least about 100 g of crude sodium chlorite with the liquid.

Embodiment G32. The method of any one of embodiments G1-G30, wherein the contacting the crude sodium chlorite with the liquid comprises contacting at least about 500 g of crude sodium chlorite with the liquid.

Embodiment G33. The method of any one of embodiments G1-G30, wherein the contacting the crude sodium chlorite with the liquid comprises contacting at least about 1,000 g of crude sodium chlorite with the liquid.

Embodiment G34. The method of any one of embodiments G1-G30, wherein the contacting the crude sodium chlorite with the liquid comprises contacting at least about 1,500 g of crude sodium chlorite with the liquid.

Embodiment G35. The method of any one of embodiments G1-G34, wherein the obtaining the purified sodium chlorite obtains at least about 1 kg of purified sodium chlorite.

Embodiment G36. A method comprising:
a) substantially dissolving crude sodium chlorite in a liquid at a temperature from about 50° C. to 100° C. with agitation thereby generating a sodium chlorite mixture, wherein the crude sodium chlorite is up to about 80% pure, wherein the liquid comprises water;
b) passing the sodium chlorite mixture through a filter to a glass chamber, wherein the glass chamber is airtight and is substantially free of air, metal, acid, and organic chemicals;
c) freezing the sodium chlorite mixture in the glass chamber to provide a frozen sodium chlorite mixture;
d) heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; and
e) separating the solid phase from the liquid phase by filtration, wherein the solid phase comprises crystalline sodium chlorite.

Embodiment G37. The method of embodiment G36, wherein the water comprises pharma water.

Embodiment G38. The method of embodiment G36, wherein the water comprises water for injection.

Embodiment G39. The method of any one of embodiments G36-G38, wherein the dissolving is performed at a temperature of about 70° C.

Embodiment G40. The method of any one of embodiments G36-G39, wherein the filter is a 0.2 micro cartridge filter.

Embodiment G41. The method of any one of embodiments G36-G40, wherein the heating the frozen sodium chlorite mixture is to about 10° C.

Embodiment G42. The method of any one of embodiments G36-G41, further comprising measuring a purity of the purified sodium chlorite, and: i) if the purity meets a threshold purity value, collecting the sodium chlorite; or ii) if the purity does not meet the threshold purity value, dissolving purified the sodium chlorite in a solvent and recrystallizing the purified sodium chlorite from the solvent, wherein the threshold purity value is at least 96% pure.

Embodiment G43. The method of any one of embodiments G36-G42, further comprising transferring the purified sodium chlorite to a container.

Embodiment G44. The method of any one of embodiments G36-G43, further comprising dissolving the purified sodium chlorite in water.

Embodiment G45. The method of any one of embodiments G36-G44, further comprising dissolving the purified sodium chlorite in water to provide dissolved sodium chlorite, wherein the dissolved sodium chlorite is in water at a level of about 100 mg/mL to about 125 mg/mL.

Embodiment G46. The method of any one of embodiments G36-G45, further comprising processing the purified sodium chlorite into a plurality of unit dosage forms, wherein each unit dosage form independently comprises purified sodium chlorite dissolved in phosphate buffer at a pH of about 7 to about 11.

Embodiment G47. The method of embodiment G46, further comprising packaging the plurality of unit dosage forms into pharmaceutically-acceptable packaging.

Embodiment G48. The method of any one of embodiments G36-G47, wherein the crude sodium chlorite has a mass of at least about 100 g.

Embodiment G49. The method of any one of embodiments G36-G47, wherein the crude sodium chlorite has a mass of at least about 500 g.

Embodiment G50. The method of any one of embodiments G36-G47, wherein the crude sodium chlorite has a mass of at least about 1,000 g.

Embodiment G51. The method of any one of embodiments G36-G47, wherein the crude sodium chlorite has a mass of at least about 1,500 g.

Embodiment G52. The method of any one of embodiments G36-G51, wherein the solid phase comprises crystalline sodium chlorite in an amount of at least about 1 kg of purified sodium chlorite.

1-93. (canceled)

94. A method comprising:
a) substantially dissolving crude sodium chlorite in a liquid at a temperature from about 50° C. to 100° C. with agitation thereby generating a sodium chlorite mixture, wherein the crude sodium chlorite is up to about 80% pure, wherein the liquid comprises water;
b) passing the sodium chlorite mixture through a filter to a glass chamber, wherein the glass chamber is airtight and is substantially free of air, metal, acid, and organic chemicals;
c) freezing the sodium chlorite mixture in the glass chamber to provide a frozen sodium chlorite mixture;
d) heating the frozen sodium chlorite mixture to within a range of about 5° C. to about 20° C., wherein the heating the frozen sodium chlorite mixture to within the range of about 5° C. to about 20° C. generates a mixture of a solid phase and a liquid phase from the frozen sodium chlorite mixture; and
e) separating the solid phase from the liquid phase by filtration, wherein the solid phase comprises crystalline sodium chlorite.

95. The method of claim 94, wherein the water comprises pharma water.

96. The method of claim 94, wherein the water comprises water for injection.

97. The method of claim 94, wherein the dissolving is performed at a temperature of about 70° C.

98. The method of claim 94, wherein the filter is a 0.2 micro cartridge filter.

99. The method of claim 94, wherein the heating the frozen sodium chlorite mixture is to about 10° C.

100. The method of claim 94, further comprising measuring a purity of the purified sodium chlorite, and: i) if the purity meets a threshold purity value, collecting the sodium chlorite; or ii) if the purity does not meet the threshold purity value, dissolving purified the sodium chlorite in a solvent and recrystallizing the purified sodium chlorite from the solvent, wherein the threshold purity value is at least 96% pure.

101. The method of claim 94, further comprising transferring the purified sodium chlorite to a container.

102. The method of claim 94, further comprising dissolving the purified sodium chlorite in water.

103. The method of claim 94, further comprising dissolving the purified sodium chlorite in water to provide dissolved sodium chlorite, wherein the dissolved sodium chlorite is in water at a level of about 100 mg/mL to about 125 mg/mL.

104. The method of claim 94, further comprising processing the purified sodium chlorite into a plurality of unit dosage forms, wherein each unit dosage form independently comprises purified sodium chlorite dissolved in phosphate buffer at a pH of about 7 to about 11.

105. The method of claim 94, further comprising packaging the plurality of unit dosage forms into pharmaceutically-acceptable packaging.

106. The method of claim 94, wherein the crude sodium chlorite has a mass of at least about 100 g.

107. The method of claim 94, wherein the crude sodium chlorite has a mass of at least about 500 g.

108. The method of claim 94, wherein the crude sodium chlorite has a mass of at least about 1,000 g.

109. The method of claim 94, wherein the crude sodium chlorite has a mass of at least about 1,500 g.

110. The method of claim 94, wherein the solid phase comprises crystalline sodium chlorite in an amount of at least about 1 kg of purified sodium chlorite.
